(19) United States
(12) Patent Application Publication
(10) Pub. No.: US 2016/0171473 A1
(43) Pub. Date: Jun. 16, 2016

(54) SYSTEM AND METHOD FOR CUSTOMIZING A PRODUCE SCALE MENU AT A RETAIL ENTERPRISE BASED ON CUSTOMER PURCHASE HISTORY

(71) Applicant: Meijer, Inc., Grand Rapids, MI (US)

(72) Inventors: Brian Pugh, Grand Rapids, MI (US); Elmer L. Robinson, JR., Marne, MI (US); David Scott Pallas, Hudsonville, MI (US); K. Michael Ross, Grand Rapids, MI (US)

(21) Appl. No.: 14/965,844

(22) Filed: Dec. 10, 2015

Related U.S. Application Data
(60) Provisional application No. 62/090,236, filed on Dec. 10, 2014.

(51) Int. Cl. G06Q 20/20; G01G 19/414

(52) U.S. Cl. CPC G06Q 20/208; G01G 19/4144

(57) ABSTRACT

Disclosed is a system and method for customizing produce scale menus. Produce scales located in a brick-and-mortar store are associated in a database with different device codes, and customer purchase histories are associated in a database with different customer codes each identifying a different customer. Each purchase history contains items previously purchased by a corresponding customer. In response to receipt of a device code and a customer code, the device code in the database that matches the received device code is identified, the customer code in the database that matches the received customer code is identified, and if the purchase history associated in the database with the identified customer code contains one or more produce items, a produce menu displayed by the produce scale associated in the database with the identified device code is modified to display the at least one of the produce items in the purchase history.

### CROSS-REFERENCE TO RELATED APPLICATION

This patent application claims the benefit of, and priority to, U.S. Provisional Patent Application Ser. No. 62/090,236, filed Dec. 10, 2014, the disclosure of which is expressly incorporated herein by reference.

### FIELD OF THE INVENTION

The present invention relates generally to systems and methods for controlling display screens of produce scales located at brick-and-mortar stores of retail enterprises, and more specifically to systems and methods for selectively modifying produce menus displayed on such display screens to display one or more produce items contained in customer purchase histories.

### BACKGROUND

Retailers of goods and services typically offer such goods and services for purchase via one or more conventional brick-and-mortar retail stores. In some stores, the goods may be or include produce items, and in such cases one or more produce scales may be located within one or more brick-and-mortar stores via which customers can weigh and obtain pricing for various produce items. For example, one or more such produce scales may be located at and coupled to self-checkout and/or employee-operated point-of-sale systems, and/or one or more may be located at one or more alternate locations within the brick-and-mortar store, e.g., at or near one or more produce aisles or otherwise located within or adjacent to a produce area of the brick-and-mortar store, or the like. Many modern produce scales include a display screen which displays a searchable menu of produce items. Such produce items menus may typically include multiple pages of produce items that customers and/or store employees can access to search for produce items that match those being purchased.

### SUMMARY

The present invention may comprise one or more of the features recited in the attached claims, and/or one or more of the following features and combinations thereof. In one aspect, a method of customizing a produce scale menu at a retail enterprise may comprise associating, with a processor in a first database, each of a plurality of produce scales with a different one of a plurality of device codes, each of the plurality of produce scales located in a brick-and-mortar store of the retail enterprise, associating, with the processor in the first or a second database, each of a plurality of customer codes with a different one of a plurality of purchase histories and also with a different one of a plurality of customers of the retail enterprise, each of the plurality of purchase histories containing information relating to items previously purchased by a corresponding one of the plurality of customers, in response to receipt of a device code, identifying with the processor the one of the plurality of device codes in the first database that matches the received device code, in response to receipt of a customer code, identifying with the processor the one of the plurality of customer codes in the first or the second database that matches the received customer code, and if the one of the plurality of purchase histories associated in the first or the second database with the identified one of the plurality of customer codes contains at least one produce item, modifying a produce menu displayed on a display device of the one of the plurality of produce scales associated in the first database with the identified one of the device codes to display the at least one produce item.

In some embodiments, the customer code may be received from one or more input devices associated with and located at the identified one of the produce scales or associated with and located at a point-of-sale system at which the identified one of the produce scales is located and to which the identified one of the produce scales is coupled. In some such embodiments, the device code may be received directly from the identified one of the produce scales or the point-of-sale system at which the identified one of the produce scales is located or received from a database in which the device code is associated with the corresponding produce scale or point-of-sale system. In other embodiments, the customer code and/or the device code may be received in the form of, i.e., carried by, one or more wireless signals transmitted by a mobile communication device carried by the customer. One or more combinations of the embodiments just described are contemplated by this disclosure.

In another aspect, a system for customizing a produce scale menu at a retail enterprise may comprise a plurality of produce scales located in one or more brick-and-mortar stores of the retail enterprise, each of the plurality of produce scales having a display screen to display a menu of produce items, a plurality of wireless signal broadcasting devices each located at or near a different one of the plurality of produce scales, at least one database having stored therein a plurality of device codes each associated with a different one of the plurality of wireless signal broadcasting devices and also with a corresponding one of the plurality of produce scales at or near which each different wireless signal broadcasting device is located, and a plurality of customer codes each associated with a different one of a plurality of customers of the retail enterprise and each also associated with a different one of a plurality different purchase histories, each of the plurality of purchase histories containing information relating to items previously purchased by a corresponding one of the plurality of customers, a processor, and memory having instructions stored therein which, when executed by the processor, cause the processor to identify, in response to a wirelessly received device code, the one of the plurality of produce scales associated in the at least one database with the one of the plurality of device codes that matches the wirelessly received device code, to identify, in response to a wirelessly received customer code, the one of the plurality of purchase histories associated in the at least one database with the one of the plurality of customer codes that matches the wirelessly received customer code, and to control the display screen of the identified one of the plurality of produce scales to modify the menu of produce items displayed thereon to display at least produce item contained in the identified one of the plurality of purchase histories.

In yet another aspect, a system for customizing a produce scale menu at a retail enterprise may comprise a plurality of produce scales located in one or more brick-and-mortar stores of the retail enterprise, each of the plurality of produce scales having a display screen to display a menu of produce items, a plurality of wireless signal broadcasting devices each located at or near a different one of the plurality of produce scales, at least one database having stored therein a plurality of device codes each associated with a different one of the plurality of wireless signal broadcasting devices and also with a corresponding one of the plurality of produce scales at or near which each different wireless signal broadcasting device is located, and a plurality of customer codes each associated with a different one of a plurality of customers of the retail enterprise and each also associated with a different one of a plurality different purchase histories, each of the plurality of purchase histories containing information relating to items previously purchased by a corresponding one of the plurality of customers, and a server coupled to each of the plurality of point-of-sale system, the server including at least a first module to identify, in response to a wirelessly received device code, the one of the plurality of produce scales associated in the at least one database with the one of the plurality of device codes that matches the wirelessly received device code, to identify, in response to a wirelessly received customer code, the one of the plurality of purchase histories associated in the at least one database with the one of the plurality of customer codes that matches the wirelessly received customer code, and to control the display screen of the identified one of the plurality of produce scales to modify the menu of produce items displayed thereon to display at least produce item contained in the identified one of the plurality of purchase histories.

In still another aspect, a non-transitory machine-readable medium may comprise a plurality of instructions which, when executed by at least one processor, result in the at least one processor associating in at least one database each of a plurality of produce scales with a different one of a plurality of device codes, each of the plurality of produce scales located in a brick-and-mortar store of the retail enterprise, associating in the at least one database each of a plurality of customer codes with a different one of a plurality of purchase histories and also with a different one of a plurality of customers of the retail enterprise, each of the plurality of purchase histories containing information relating to items previously purchased by a corresponding one of the plurality of customers, in response to a wirelessly received device code, identifying the one of the plurality of device codes in the at least one database that matches the received device code, in response to a wirelessly received customer code, identifying the one of the plurality of customer codes in the at least one database that matches the received customer code, and modifying a produce menu displayed on a display device of the one of the plurality of produce scales associated in the at least one database with the identified one of the device codes to display at least one produce item contained in the one of the plurality of purchase histories associated in the at least one database with the identified one of the plurality of customer codes.

In a further aspect, a system for customizing a produce scale menu at a retail enterprise may comprise a plurality of point-of-sale systems in a brick-and-mortar store of the retail enterprise, a plurality of produce scales each located at and coupled to a different one of the plurality of point-of-sale systems and each having a display screen to display a menu of produce items, a plurality of wireless signal broadcasting devices each located at or near a different one of the plurality of point-of-sale systems, at least one database having stored therein a plurality of device codes each associated with a different one of the plurality of wireless signal broadcasting devices and also with a corresponding one of the plurality of point-of-sale systems at or near which each different wireless signal broadcasting device is located, and a plurality of customer codes each associated with a different one of a plurality of customers of the retail enterprise and each also associated with a different one of a plurality different purchase histories, each of the plurality of purchase histories containing information relating to items previously purchased by a corresponding one of the plurality of customers, a processor, and memory having instructions stored therein which, when executed by the processor, cause the processor to identify, in response to a wirelessly received device code, the one of the plurality of point-of-sale systems associated in the at least one database with the one of the plurality of device codes that matches the wirelessly received device code, to identify, in response to a wirelessly received customer code, the one of the plurality of purchase histories associated in the at least one database with the one of the plurality of customer codes that matches the wirelessly received customer code, and to control the display screen of the one of the plurality of produce scales coupled to the identified one of the plurality of point-of-sale systems to modify the menu of produce items displayed thereon to display at least produce item contained in the identified one of the plurality of purchase histories.

In yet a further aspect, a system for customizing a produce scale menu at a retail enterprise may comprise a plurality of point-of-sale systems in a brick-and-mortar store of the retail enterprise, a plurality of produce scales each located at and coupled to a different one of the plurality of point-of-sale systems and each having a display screen to display a menu of produce items, a plurality of wireless signal broadcasting devices each located at or near a different one of the plurality of point-of-sale systems, at least one database having stored therein a plurality of device codes each associated with a different one of the plurality of wireless signal broadcasting devices and also with a corresponding one of the plurality of point-of-sale systems at or near which each different wireless signal broadcasting device is located, and a plurality of customer codes each associated with a different one of a plurality of customers of the retail enterprise and each also associated with a different one of a plurality different purchase histories, each of the plurality of purchase histories containing information relating to items previously purchased by a corresponding one of the plurality of customers, and a server coupled to each of the plurality of point-of-sale system, the server including at least a first module to identify, in response to a wirelessly received device code, the one of the plurality of point-of-sale systems associated in the at least one database with the one of the plurality of device codes that matches the wirelessly received device code, to identify, in response to a wirelessly received customer code, the one of the plurality of purchase histories associated in the at least one database with the one of the plurality of customer codes that matches the wirelessly received customer code, and to control the display screen of the one of the plurality of produce scales coupled to the identified one of the plurality of point-of-sale systems to modify the menu of produce items displayed thereon to display at least produce item contained in the identified one of the plurality of purchase histories.

In still a further aspect, a non-transitory machine-readable medium may comprise a plurality of instructions which, when executed by at least one processor, result in the at least one processor associating in at least one database each of a plurality of point-of-sale systems with a different one of a plurality of device codes, each of the plurality of point-of-sale systems located in a brick-and-mortar store of the retail enterprise and each coupled to a different one of a plurality of produce scales, each of the plurality of produce scales located in a brick-and-mortar store of the retail enterprise, associating in the at least one database each of a plurality of customer codes with a different one of a plurality of purchase histories and also with a different one of a plurality of customers of the retail enterprise, each of the plurality of purchase histories containing information relating to items previously purchased by a corresponding one of the plurality of customers, in response to a wirelessly received device code, identifying the one of the plurality of device codes in the at least one database that matches the received device code, in response to a wirelessly received customer code, identifying the one of the plurality of customer codes in the at least one database that matches the received customer code, and modifying a produce menu displayed on a display device of the one of the plurality of produce scales coupled to the one of the plurality of point-of-sale systems associated in the at least one database with the identified one of the device codes to display at least one produce item contained in the one of the plurality of purchase histories associated in the at least one database with the identified one of the plurality of customer codes.

### BRIEF DESCRIPTION OF THE DRAWINGS

This disclosure is illustrated by way of example and not by way of limitation in the accompanying figures. Where considered appropriate, reference labels have been repeated among the figures to indicate corresponding or analogous elements.

FIG. 1 is a simplified block diagram of an embodiment of a system for customizing produce scale menus at a retail enterprise based on customer purchase histories.

FIG. 2 is a simplified block diagram of an embodiment of one of the point-of-sale systems illustrated in FIG. 1.

FIG. 3A is a simplified block diagram of an embodiment of one of the mobile communication devices illustrated in FIG. 1.

FIG. 3B is a simplified block diagram of an embodiment of one of the user computing devices illustrated in FIG. 1.

FIG. 4 is a simplified bock diagram of an embodiment of one of the produce scales illustrated in FIGS. 1 and 2.

FIG. 5 is a simplified block diagram of an embodiment of an environment of the main server of FIG. 1.

FIG. 6A is a simplified flow diagram of an embodiment of a process for identifying a customer and a produce scale at a brick-and-mortar outlet of the retail enterprise.

FIG. 6B is a simplified flow diagram of another embodiment of a process for identifying a customer at a brick-and-mortar outlet of the retail enterprise.

FIG. 7 is a simplified diagram illustrating an embodiment of a communications framework for detecting by a mobile communication device of wireless signals produced by a wireless signal broadcasting device associated with a produce scale and/or point-of-sale system and for conducting wireless communications relating thereto between the mobile communication device and the main server of the retail enterprise.

FIG. 8 is a simplified flow diagram of an embodiment of the produce scale menu control process executed as part of either of the processes illustrated in FIGS. 6A and 6B.

FIG. 9A is a block diagram illustrating an embodiment of a produce menu displayed on the display screen of one of the produce scales illustrated in FIG. 1 and/or FIG. 2.

FIG. 9B is a block diagram illustrating an embodiment of a modified produce menu displayed on the display screen of one of the produce scales illustrated in FIG. 1 and/or FIG. 2.

FIG. 10A is a simplified flow diagram of an embodiment of the produce scale operation process executed as part of the process illustrated in FIG. 8.

FIG. 10B is a simplified flow diagram of another embodiment of the produce scale operation process executed as part of the process illustrated in FIG. 8.

FIG. 11 is a simplified flow diagram of an embodiment of the produce scale data processing process executed as part of the processes illustrated in each of FIGS. 10A and 10B.

FIG. 12 is a simplified flow diagram of an embodiment of a purchase transaction process for processing purchase transactions which include one or more pre-processed produce items.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure, process, process step or characteristic is described in connection with an embodiment, it is submitted that it is within the knowledge of one skilled in the art to effect such feature, structure, process, process step or characteristic in connection with other embodiments whether or not explicitly described. Further still, it is contemplated that any single feature, structure, process, process step or characteristic, and/or any subset of features, structures, process, process steps or characteristics, disclosed herein may be combined with any one or more other disclosed feature, structure, process, process step or characteristic, whether or not explicitly described, and it will be understood that no limitations on the types and/or number of such combinations are therefore intended or should be inferred.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on one or more machine-readable media, which may be read and executed by one or more processors. A machine-readable medium should be understood to mean a non-transitory machine-readable medium, i.e., one that does not include transitory signals, and such a machine-readable medium may illustratively be embodied as any device or physical structure for storing or transmitting information in a form readable by a machine (e.g., a computing device). For example, and without limitation, a machine-readable medium may be embodied as any one or combination of read only memory (ROM); random access memory (RAM); magnetic disk storage media; optical storage media; flash memory devices; and others.

### System Components

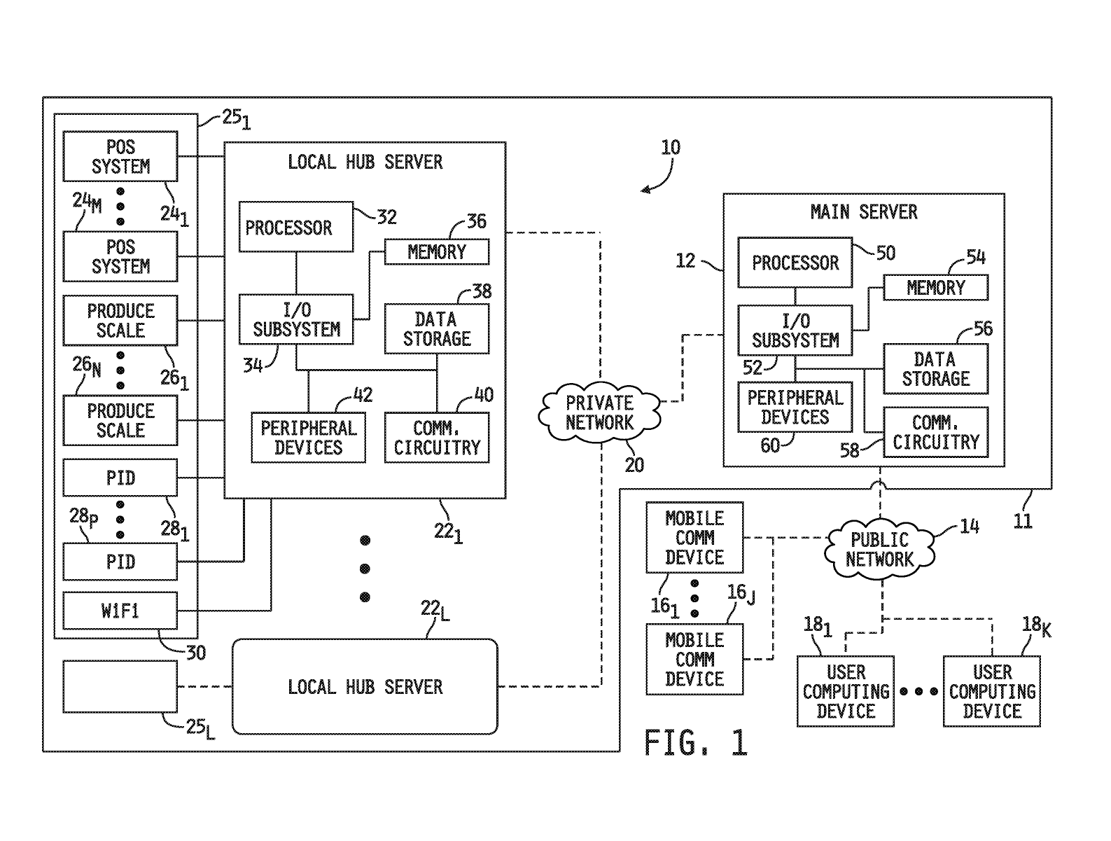

Referring now to FIG. 1, a system 10 is shown for customizing produce scale menus at a retail enterprise base, at least in part, on customer purchase histories. The system 10 includes a retail enterprise 11 having a main server 12 configured to communicate with customers of the retail enterprise via a public network 14, e.g., the Internet, and customers may access the public network 14 using any conventional public network accessible electronic device and/or system. In the illustrated embodiment, for example a number, J, of mobile communication devices 16₁-16_{J} are shown, where J may be any positive integer. The retail enterprise 11 may include any number, L, of brick-and-mortar retail stores or locations 25₁-25_{L} each having one or more point-of-sale systems 24₁-24_{M} operating therein, each having any number, N, of produce scales 26₁-26_{N} operating therein, and each including any number, P, of position identification devices (PIDs) 28₁-28_{P}, wherein L, N and P may each by any positive integer. As used herein, the phrases “brick-and-mortar enterprise location” and brick-and-mortar store” will be understood to be synonymous. In any case, the main server 12 is configured to communicate with each such point-of-sale (POS) system 24₁-24_{M}, each of which operates in a conventional manner to process items to be purchased by customers during purchase transactions. In some embodiments, as will be described in greater detail below, the main server 12 may be coupled, e.g., via a private network 20, to one or more local hub servers 22₁-22_{L} each associated with one of the brick-and-mortar stores 25₁-25_{L}, wherein each such hub server 22₁-22_{L} is communicatively coupled to the POS system(s) 24₁-24_{M}, to the produce scales 26₁-26_{N}, and to one or more of the position identification device(s) 28₁-28_{P}. In some alternate embodiments, some or all of the local hub servers 22₁-22_{L} may be omitted and for each such omitted local hub server 22₁-22_{L}, the main server 12 may be coupled directly to the corresponding POS system(s) 24₁-24_{M}, to the produce scales 26₁-26_{N}, and to one or more of the position identification device(s) 28₁-28_{P}. In other alternate embodiments, one or more of the position identification devices 28₁-28_{P} may not be communicatively coupled to the corresponding hub server 22 (or to the main server 12), but may instead be coupled only to a source of electrical power or to nothing at all.

Also depicted in FIG. 1 are a number of conventional produce scales 26₁-26_{N} each illustratively coupled to the local hub server 22 in a different one of the brick-and-mortar enterprise locations 25₁-25_{L} such that each brick-and-mortar enterprise location includes one or more such produce scales 26₁-26_{N}. In alternate embodiments, one or more or all of the produce scales 26₁-26_{N} may not be coupled to the local hub server 22 but may instead be coupled directly, e.g., via the private network 20, to the main server 12. Any of the one or more produce scales 26₁-26_{N} may be located in a brick-and-mortar store 25₁-25_{L} remotely from, or at least not part of or associated with any of, the point-of-sale systems 24₁-24_{M}, e.g., located in or near a produce section or department of a brick-and-mortar store 25.

Each of the brick-and-mortar stores 25₁-25_{L} may further include at least one conventional WiFi Access Point 30 which may be coupled to the corresponding local hub server 22₁-22_{L}, or directly to the main server 12 in any one or more of the brick-and-mortar stores 25₁-25_{L} not having an associated local hub server 22₁-22_{L}. Each such WiFi Access Point 30 is illustratively controlled by the main server 12 (or corresponding local hub server 22) in a conventional manner to establish at least one corresponding Internet hotspot within the brick-and-mortar store 25 via which customers (and employees) can access the public network 14, e.g., to access the Internet, using any conventional public network accessible electronic device and/or system, e.g., such as with any of the plurality of mobile communication devices 16₁-16_{K}.

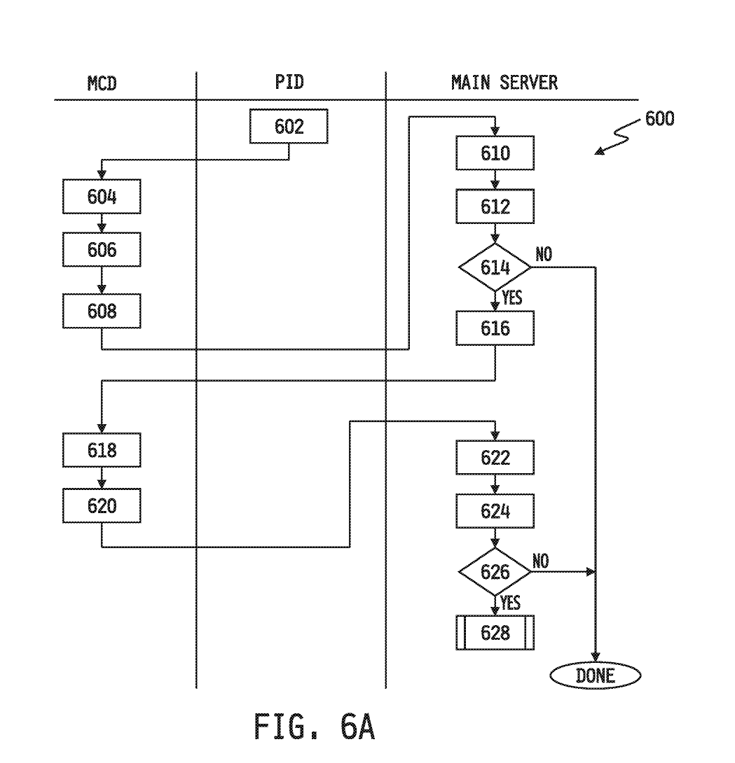

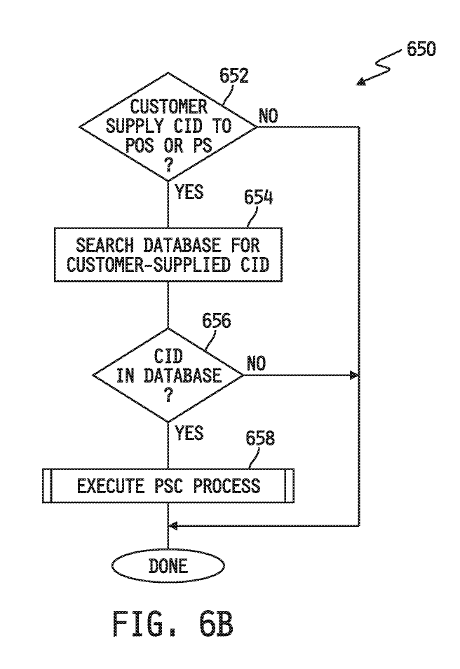

As illustrated in FIG. 1, one or more of the brick-and-mortar stores 25₁-25_{L} may include one or more position identification devices 28₁-28_{P} (PIDs) via which the position or location of a customer's (and/or employee's) mobile communication device 16₁-16_{K}, and thus the position or location of the associated customer (or employee), relative to the brick-and-mortar stores 25₁-25_{L}, and/or relative to one or more structures or locations within an identified one of the brick-and-mortar stores 25₁-25_{L} can be determined. Examples of various embodiments of the one or more position identification devices 28₁-28_{P} and their operation will be described in detail hereinafter with respect to FIGS. 6A, 6B and 7.

In the embodiment illustrated in FIG. 1, the main server 12 is illustratively coupled via a private network 20 to a plurality of local hub servers 22, each associated with a different one of the one or more brick-and-mortar stores 25₁-25_{L}. Some retail enterprises 11 may include a single brick and mortar outlet 25, and other larger retail enterprises 11 may include two or more physically remote brick and mortar outlets 25₁-25_{L}. In the latter case, the retail enterprise 11 may include, for example, a main physical location with two or more remote physical locations, and for purposes of this document the two or remote physical locations in such an arrangement are referred to as “hub” locations. In this disclosure, the system 10 will be illustrated and described in the context of such a larger retail enterprise having a main physical location and two or more physical hub locations. In this regard, the main server 12 in the system 10 shown in FIG. 1 will typically be located at a main business location of the retail enterprise, and will be coupled via the network 20 to two or more local hub servers 22, each of which will typically be located at a different one of the two or more hub locations. In embodiments which do not include any local hub servers 22₁-22_{L}, the main server 12 will be coupled via the network 20 to the one or more POS systems 24₁-24_{M}, to the one or more produce scales 26₁-26_{N}, to the one or more position identification devices (PIDs) 28₁-28_{P} (in embodiments in which the one or more PIDs 28₁-28_{P} is/are directly coupled to any device or system), and to the at least one WiFi Access Point 30. In any case, communicative coupling between the local hub server 22 or the main server 12 and the one or more point-of-sale systems 24₁-24_{M}, to the one or more produce scales 26₁-26_{N}, the one or more PIDs 28₁-28_{P} and the at least one WiFi Access Point 30 may be accomplished using any known hardwire and/or wireless communication coupling, and communications over any such hardwire and/or wireless coupling may be accomplished using any known communication protocol.

In some alternative embodiments, as described above, one or more (or all) of the local hub servers 22₁-22_{L} may be omitted. In other alternative embodiments, the main server 12 may be omitted and at least one of the local hub servers 22 may be configured to act as a so-called master server with the remaining local hub servers 22 configured to act as so-called slave servers. In still other alternative embodiments in which the retail enterprise 11 includes only a single brick and mortar outlet, the local hub servers 22 may be or include the main server 12 or vice versa. For purposes of the following description, any process disclosed as being controlled by the main server 12 may, in some embodiments, instead be controlled, in whole or in part, by one or more local hub servers 22 and vice versa, and/or may be controlled, in whole or in part, by one of the point-of-sale systems 24₁-24_{M} and vice versa and/or may be controlled, in whole or in part, by one of the produce scales 26₁-26_{N}, and vice versa.

In embodiments which include one or more local hub servers 22₁-22_{L}, each such local hub server 22 may be embodied as any type of server (e.g., a web server) or similar computing device capable of performing the functions described herein. In the illustrative embodiment of FIG. 1, the local hub server 22 includes a processor 32, an I/O subsystem 34, a memory 36, a data storage 38, a communication circuitry 40, and one or more peripheral devices 42. It should be appreciated that the local hub server 22 may include other components, sub-components, and devices commonly found in a server and/or computing device, which are not illustrated in FIG. 1 for clarity of the description.

The processor 32 of the local hub server 22 may be embodied as any type of processor capable of executing software/firmware, such as a microprocessor, digital signal processor, microcontroller, or the like. The processor 32 may be a single processor or include multiple processors. The I/O subsystem 34 of the local hub server 22 may be embodied as circuitry and/or components to facilitate input/output operations with the processor 32 and/or other components of the local hub server 22. The processor 32 is communicatively coupled to the I/O subsystem 34.

The memory 36 of the user local hub server 22 may be embodied as or otherwise include one or more conventional volatile and/or non-volatile memory devices. The memory 36 is communicatively coupled to the I/O subsystem 34 via a number of signal paths. Although only a single memory device 36 is illustrated in FIG. 1, the local hub server 22 may be or include any number of memory devices. Various data and software may be stored in the memory 36. The data storage 38 is also communicatively coupled to the I/O subsystem 34 via a number of signal paths, and may be embodied as any type of device or devices configured for the short-term or long-term storage of data such as, for example, memory devices and circuits, memory cards, hard disk drives, solid-state drives, or other data storage devices.

The communication circuitry 40 of the local hub server 22 may include any number of devices and circuitry for enabling communications between the local hub sever 22 and the main server 12 and/or between the local hub server 22 and the one or more point-of-sale systems 24₁-24_{M} and/or between the local hub server 22 and the one or more produce scales 26₁-26_{N} (and/or, in some embodiments, between the local hub server 22 and the one or more position identification devices 28₁-28_{P}). In the illustrated embodiment, for example, communication between the local hub server 22 and the main server 12 takes place wirelessly via the network 20, wherein the network 20 may represent, for example, a private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the local hub server 22 and the main server 12 may be a non-private network and/or may be, in whole or in part, a wired connection. Generally, the communication circuitry 40 may be configured to use any one or more, or combination, of conventional secure and/or unsecure communication protocols to communicate with the main server 12. As such, the network 20 may include any number of additional devices, such as additional computers, routers, and switches, to facilitate communications between the local hub server 22 and the main server 12. Communication between the local hub server 22 and the one or more point-of-sale systems 24₁-24_{M}, between the local hub server 22 and the one or more produce scales 26₁-26_{N} (and/or, in some embodiments, between the local hub server 22 and the one or more position identification devices 28₁-28_{P}) may take place via one or more such wireless communication interfaces and/or via one or more conventional wired interfaces.

In some embodiments, the local hub server 22 may also include one or more peripheral devices 42. Such peripheral devices 42 may include, for example, but are not limited to, any number of additional input/output devices, interface devices, and/or other peripheral devices. For example, the peripheral devices 42 may include a display, a keyboard, a mouse, audio processing circuitry, and/or other input/output devices.

Others of the local hub servers 22₁-22_{L}, e.g., serving other brick-and-mortar locations 25₁-25_{L}, may be substantially similar to the local hub server 22 and include similar components. As such, the description provided above of the components of the local hub server 22 may be equally applicable to such similar components of other local hub servers and are not repeated herein so as not to obscure the present disclosure. Of course, it should be appreciated that in some embodiments one or more of the local hub servers 22 and may be dissimilar to others of the local hub servers 22.

An embodiment of the main server 12 is also illustrated in FIG. 1, and generally includes the same components as the local hub server 22. For example, a processor 50 is coupled to an I/O subsystem 52, and the I/O subsystem 52 is coupled to a memory 54, a data storage unit 56, communication circuitry 58 and one or more peripheral devices 60. In some embodiments, each of the foregoing components may be identical to corresponding components of the local hub server 22 described above, and a detailed explanation of such components will not be repeated here for brevity. In other embodiments, the main server 12 may be configured differently than the local hub server 22 described above. In any case, the communication circuitry 40 of each of the local hub servers 22 facilitates communication with the communication circuitry 58 of the main server 12 and vice versa so that information can be shared between the main server 12 and each of the one or more local hub servers 22 via the network 20. Although only one such main server 12 is shown in FIG. 1, it should be appreciated that, in other embodiments, the system 10 may include any number of main servers, and in still other embodiments the main server 12 may be communicatively coupled to one or more remote servers of the retail enterprise. Any such one or more remote servers may include any structure or feature illustrated and described herein with respect to the main server 12, and may be configured to execute any one or more functions described with respect to the main server 12 either alternatively to the main server 12 or in addition to the main server 12. In any case, the main server 12 may be embodied as any type of server (e.g., a web server) or similar computing device capable of performing the functions described herein.

In embodiments in which the one or more point-of-sale systems 24₁-24_{M}, the one or more produce scales 26₁-26_{N}, the one or more position identification devices 28₁-28_{P} and the WiFi Access Point 30 are controlled by the main server 12 (in embodiments in which the one or more position identification devices 28₁-28_{P} are controlled by the main server 12 at all), and also in embodiments in which such components are controlled by one or more of the local hub servers 22₁-22_{L}, it will be understood that any such server may be or include a single server, multiple servers, one or more cloud servers, i.e., one or more dedicated hosting and/or shared hosting, off-site servers providing server resources to the retail enterprise according to a rental or lease arrangement, one or more shared-processor servers, two or more point-to-point server, or the like.

The mobile communication devices 16₁-16_{J} illustrated in FIG. 1 are intended to depict mobile communication devices that are each separately owned and/or operated by a different customer (and, in some embodiments by employees of the retail enterprise 11). No limit on the total number of such mobile communication devices 16₁-16_{J} that may be owned and operated by any one customer (or employee), or on the total number of such mobile communication devices 16₁-16_{J} that may communicate with the main server 12, is intended or should be inferred. The mobile communication devices 16₁-16_{J} may be or include any mobile electronic device capable of executing one or more application programs as described herein and of communicating with the main server 12 via the public network 14. Examples of the mobile communication devices 16₁-16_{J} include, but should not be limited to, mobile telephones, smart phones, tablet computers, personal data assistants (PDAs), wearable electronic communication devices, including eye glasses, watches, devices attached to and/or integral with clothing, headwear and/or footwear, implanted electronic communication devices, and the like. Other examples include any one or more such mobile communication devices mounted to or integral with a mobile structure and configured to communicate with, or to at least wirelessly exchange some amount of information with, any of the foregoing example customer (and/or employee) mobile communication devices, and examples of such mobile structures include, but are not limited to, a wheeled cart, such as a conventional shopping cart or other wheeled cart, basket, platform or carriage, a manually-carried shopping basket, a wheeled or non-wheeled walking aid, a wheelchair, an electrically powered or motorized vehicle such as a mobility scooter, and the like.

The user computing devices 18₁-18_{K} illustrated in FIG. 1 are intended to include any of privately owned and accessed computers, such as those residing in customer's residences, to include semi-privately owned and accessed computers, such as those residing at multiple-employee business enterprises, and publicly accessible computers, such as those available at internet cafés and kiosks. No limit on the total number of such user computing devices 18₁-18_{K} that may be owned and operated by any one customer (or employee), or on the total number of such user computing devices 18₁-18_{K} that may communicate with the main server 12, is intended or should be inferred. The user computing devices 18₁-18_{K} may be or include any computer capable of executing one or more software programs and of communicating with the main server 12 via the public network 14 for various purposes including, for example, accessing by customers of their EMS web page(s). Examples of the user computing devices 18₁-18_{K} include, but should not be limited to, personal computers (PCs), laptop computers, notebook computers and the like, whether or not networked with one or more other computing devices.

### Point-of-Sale System Components

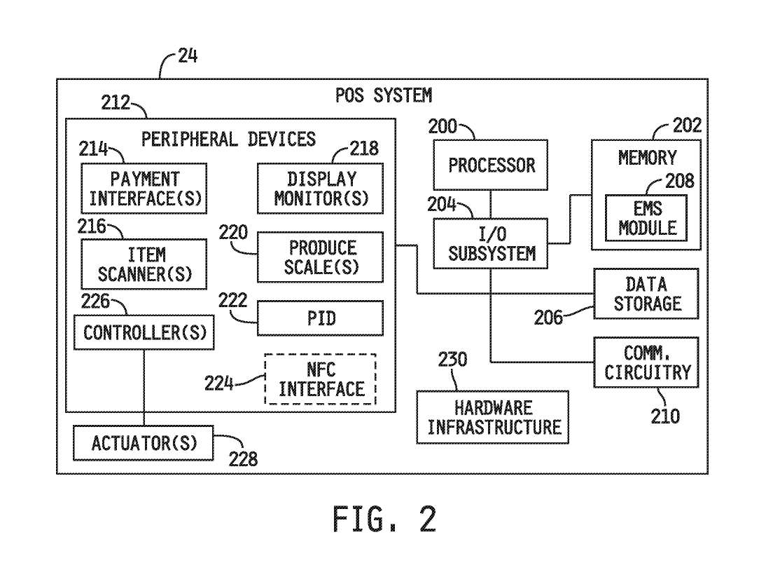

Referring now to FIG. 2, an embodiment 24 of one of the one or more point-of-sale systems, 24₁-24_{M} is shown which includes components similar to the main server 12 and also to the one or more local hub servers 22₁-22_{L}, such as a processor 200, an I/O subsystem 204, a memory 202, a data storage device 206, communication circuitry 210 and a number of peripheral devices 212. In some embodiments, each of the foregoing components may be identical to corresponding components of the local hub server 22₁ described above, and a detailed explanation of such components will not be repeated here for brevity. In other embodiments, any of the one or more point-of-sale systems 24₁-24_{M} may be configured differently than the local hub server 22₁ described above. In the illustrated embodiment, the memory 202 illustratively includes an EMS module 208 in the form of, e.g., instructions executable by the processor 200, to communicate customer-member information relating to a customer's EMS account to and from the main server 12, and to control one or more local peripheral devices to facilitate communications between customer-members of an enterprise membership service (EMS) program and the main server 12 and to facilitate manual customer input of customer-identifying information, e.g., an EMS identifying number and/or code (EMSID). The terms EMS program, EMS customer accounts and EMS identifying number and/or code, EMSID, will be described in detail below with respect to FIG. 5.

Additionally, the illustrated point-of-sale system 24 includes one or more actuators 228 and hardware infrastructure 230, examples of which will be described below. It will be appreciated that the point-of-sale system 24 may include other components, sub-components, and devices commonly found in a computer and/or computing device. In any case, the communication circuitry 210 is configured to facilitate communication with a corresponding one of the local hub servers 22₁-22_{L} and the point-of-sale system 24 may use any suitable communication protocol to communicate with the corresponding local hub server 22₁-22_{L}.

In addition to, or alternatively to, the number of peripheral devices 40 of the local hub server 22₁ described above, the number of peripheral devices 212 of the point-of-sale system 24 may include any number of other peripheral or interface devices. Examples of some of the peripheral devices 212 illustrated in FIG. 2 include, but should not be limited to, one or more conventional payment interfaces 214, one or more conventional item price scanners 216, one or more conventional display monitors 218, one or more conventional produce scales 220, one or more conventional position identification devices (PIDs) 222, one or more of which may be identical to, similar to or different from one or more of the position identification devices 28₁-28_{P}, and one or more conventional controllers 226 for controlling one or more conventional actuators 228 associated with the operation of the point-of-sale system 24. The one or more payment interfaces 214 are provided, e.g., to facilitate physical receipt of credit/debit card and/or other form of payment from customers (shoppers), and each such interface 214 may illustratively include one or more of a display, a touch screen, a keyboard, a mouse, external speakers, and/or other peripheral devices. One or more of the payment interfaces 214 may further include a produce scale 220, and one or more produce scales 220 may alternatively be coupled to the point-of-sale system 24 separately from the one or more customer payment interfaces 214. The one or more item scanner(s) 216 is/are configured to scan price code labels or other such indicators for items being purchased by customers and to also scan print media coupons.

The one or more display monitor(s) 218 provide item and/or pricing information to customers and/or enterprise employees, and may further provide additional information regarding cost and/or discounts for one or more items being purchased as well as information regarding discounts realized by customers through the use of print media and/or virtual coupons. The display monitor(s) 218 may additionally provide an interface, e.g., touchscreen or a co-located keypad, via which customers may input information such as their EMSID into the system 10.

The peripheral devices 212 of the point-of-sale system 24 further include at least one position identification device (PID) 222 via which the position and/or location of the point-of-sale system 24₁-24_{M}, relative to the brick-and-mortar stores 25₁-25_{L}, and/or relative to one or more structures or locations within an identified one of the brick-and-mortar stores 25₁-25_{L}, can be determined and/or via which the identity of the point-of-sale system 24₁-24_{M} operating within one of the brick-and-mortar stores 25₁-25_{L} can be determined. The at least one PID 222 may illustratively be mounted to or near the point-of-sale system 24. In some embodiments, the at least one PID 222 is identical in structure and operation to the PIDs 28₁-28_{P} illustrated and described herein. In some alternate embodiments, the at least one PID 222 located at or near any point-of-sale system 24₁-24_{M} may be different in structure and/or in one or more operational aspects than those of the PIDs 28₁-28_{P}. In any case, examples of various embodiments of the one or more PIDs 222 and its/their operation will be described in detail hereinafter with respect to FIGS. 6A, 6B and 7.

The peripheral devices 212 of the point-of-sale system 24 may further optionally include a near-field communication interface 224, as illustrated in dashed-line configuration in FIG. 2, which may be included in embodiments in which one or more of the mobile communication devices 16₁-16_{J} also has such a near-field communication device such that customer information, e.g., customer identification information such as one or more customer identifiers, user names, passwords, or the like, and/or customer payment information, e.g., credit/debit card information or the like, can be transferred from such one or more of the mobile communication devices 16₁-16_{J} to the point-of-sale system 24 by tapping the two near-field communication devices together or by passing the near-field communication device of a so-equipped mobile communication device 16₁-16_{J} sufficiently close to the near-field communication device 222 to effectuate such communication. Illustratively, customers may additionally transfer customer identification information to the point-of-sale system 24 via the payment interface 214, item scanner 216 or other peripheral device(s).

The point-of-sale system 24 further includes hardware infrastructure 230 which forms the structural backbone of the point-of-sale system 24. Examples of structural components that may be included in the hardware infrastructure 230 include, but should not be limited to, one or more purchased item transport units, e.g., one or more purchased item conveyance units or systems, one or more conventional purchased item bagging areas, e.g., one or more conventional item bagging carousals, one or more purchased item support units, and the like. The one or more actuators 228 may be or include any actuator that is controllable by at least one of the one or more conventional controllers 226, and which may facilitate operation and/or control of the hardware infrastructure of the point-of-sale system 24. Examples of such one or more actuators may include, but should not be limited to, one or more linear and/or rotational drive motors, one or more electronically controlled switches, and the like.

### Mobile Communication Device Components

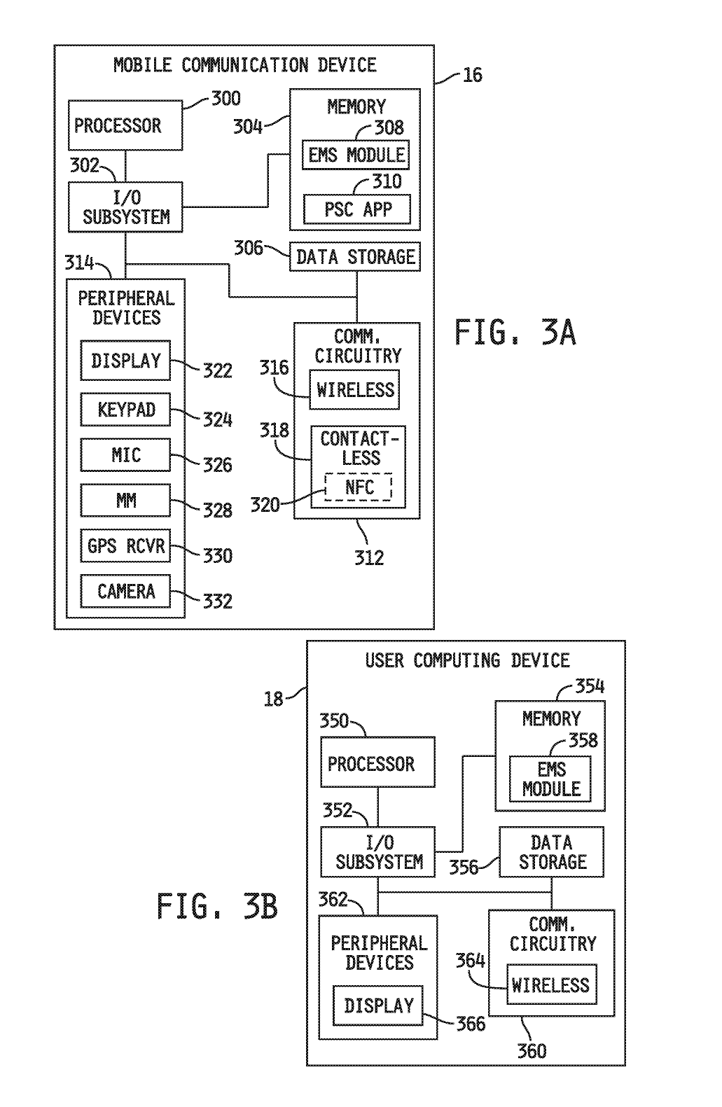

Referring now to FIG. 3A, an embodiment 16 of the mobile communication devices 16₁-16_{K} illustrated in FIG. 1 is shown which illustratively includes components similar to the main server 12 and also to the one or more local hub servers 22 and the one or more POS systems 24₁-24_{M} such as a processor 300, an I/O subsystem 302, a memory 304, a data storage device 306, communication circuitry 312 and number of peripheral devices 314. In some embodiments, each of the foregoing components may be identical to corresponding components of the local hub server 22 described above, and a detailed explanation of such components will not be repeated here for brevity. In other embodiments, any of the one or more mobile communication devices 16₁-16_{J} may be configured differently than the local hub server 22 described above. It will be appreciated that the mobile communication device 16 may include other components, sub-components, and devices commonly found in a computer and/or computing device.

The memory 304 illustratively includes an EMS module 308 in the form of, e.g., instructions executable by the processor 200, to communicate EMS customer-member information to and from the main server 12, to control one or more local peripheral devices to facilitate communications between EMS customer members and the main server 12 and to facilitate customer input into the device 16 of EMS customer information. The terms “EMS,” “EMS customer-member information” and “EMS customer members” will be defined and described hereinafter with respect to main server environment illustrated in FIG. 5. The memory 304 further illustratively includes produce scale control (PSC) application 310 in the form of, e.g., instructions executable by the processor 300, to facilitate location and identification of a mobile communication device 16 and identification of the customer carrying the mobile communication device 16, i.e., to facilitate locating and identifying the mobile communication device 16 in and/or within a particular one of the brick-and-mortar stores 25₁-25_{L}, and to facilitate identifying the customer carrying such a mobile communication device 16. Example embodiments of processes executed by the processor 300 of the customer mobile communication devices 16₁-16_{K} according to the PSC application 314 are illustrated in FIGS. 6A, 10A and 12, and such processes will be described in detail hereinafter.

In addition to, or alternatively to, the number of peripheral devices 42 of the local hub server 22 described above, the number of peripheral devices 314 of the mobile communication device 16 may include any number of other or additional peripheral or interface devices. Examples of such additional peripheral devices illustrated in FIG. 3A include, but should not be limited to, a conventional visual display unit or screen 322, a conventional global positioning system (GPS) receiver 330, a conventional camera 332, a conventional keypad 324, a conventional microphone 326 and a conventional magnetometer 328. The display 322 is configured, in a conventional manner, to be responsive to instructions produced by the processor 300 to display information thereon. The GPS receiver 330 is configured, in a conventional manner, to receive radio-frequency signals transmitted by earth-orbiting satellites and to produce corresponding signals from which geographical coordinates of the receiver 330 are or can be determined. The camera 332 is configured, in a conventional manner, to capture images and/or video and to display the same on the display 322. The keypad 324 is configured, in a conventional manner, to provide signals corresponding to manual selection and activation thereof to the processor 300, and the microphone 326 is configured, in a conventional manner, to capture sound waves and to provide signals corresponding thereto to the processor 300. The magnetometer 328 is configured, in a conventional manner, to detect local geomagnetic fields, to produce magnetic signature signals based thereon and to provide such signals to the processor 300.

The communication circuitry 312 illustratively includes conventional wireless communication circuitry 316. In some embodiments, the wireless communication circuitry 316 is configured to conduct and facilitate cellular telephone communications with other cellular and land-based communication devices. In some embodiments, the wireless communication circuitry 316 is configured to conduct and facilitate communication with the main server 12 via the network 14. In some embodiments, the wireless communication circuitry 316 is configured to access the network 14 via at least one hotspot established in any of the brick-and-mortar stores 25₁-25_{L} by a corresponding at least one WiFi Access Point 30. In some embodiments, the wireless communication circuitry 316 may further be configured to conduct and facilitate communication with one or more of the position identification devices 28₁-28_{P} in any of the brick-and-mortar stores 25₁-25_{L}. The wireless communication circuitry 316 may illustratively include conventional communication circuitry for conducting and facilitating any such communication, and examples of such conventional communication circuitry include, but are not limited to, one or more conventional radio frequency (RF) transceivers configured to receive and transmit signals at multiple radio frequencies, one or more conventional modem or other communication circuits configured to access and conduct communications via the Internet, and the like. The mobile communication device 16 may illustratively use any suitable communication protocol via the network 14 or other network to communicate with the main server 12, with other cellular and land-based communication devices and/or with one or more of the position identification devices 28₁-28_{P} in any of the brick-and-mortar stores 25₁-25_{L}.

The communication circuitry 312 may, in some embodiments, optionally include conventional contactless communication circuitry 318 such as, for example, conventional near-field communication circuitry 320 as illustrated by dashed-line representation. In such embodiments, the near-field communication circuitry 320 is illustratively configured to communicate with a near-field sensor or interface of another electronic device or system, e.g., such as an NFC interface 224 of one of more of the point-of-sale systems 24₁-24_{M}, to transfer, upon contact or near-contact therewith, information from the mobile communication device 16 to the other electronic device or system, e.g., to an NFC interface 224, and/or vice versa.

### User Computing Device Components

Referring now to FIG. 3B, an embodiment of one of the user computing devices 18 illustrated in FIG. 1 is shown, which includes components similar to the main server 12 and also to the one or more local hub servers 22₁-22_{L}, the one or more POS systems 24₁-24_{M} and the one or more mobile communication devices 16₁-16_{J}, such as a processor 350, an I/O subsystem 352, a memory 354 including an EMS module 358, a data storage device 356, communication circuitry 360 and a number of peripheral devices 362. In some embodiments, each of the foregoing components may be identical to corresponding components of the local hub server 22₁ and/or POS system 24 and/or mobile communication device 16 described above, and a detailed explanation of such components will not be repeated here for brevity. In other embodiments, any of the one or more user computing devices 18₁-18_{K} may be configured differently than the local hub server 22₁, point-of-sale system 24 and/or mobile communication device 16 described above. It will be appreciated that the user computing device 18 may include other components, sub-components, and devices commonly found in a computer and/or computing device. In any case, the communication circuitry 360 illustratively includes conventional wireless communication circuitry 364 configured to facilitate communication with the main server 12 via the network 14, and the user computing device 18 may use any suitable communication protocol to communicate with the main server 12. In addition to, or alternatively to, the number of peripheral devices 40 of the local hub server 22₁ and/or the number of peripheral devices 212 of the POS system 24 and/or the number of peripheral devices 314 of the mobile communication device 16 described above, the number of peripheral devices 362 of the user computing device 18 may include any number of other or additional peripheral or interface devices. One example of such an additional peripheral device illustrated in FIG. 3B includes, but should not be limited to, a conventional visual display unit 366.

### Produce Scale Components

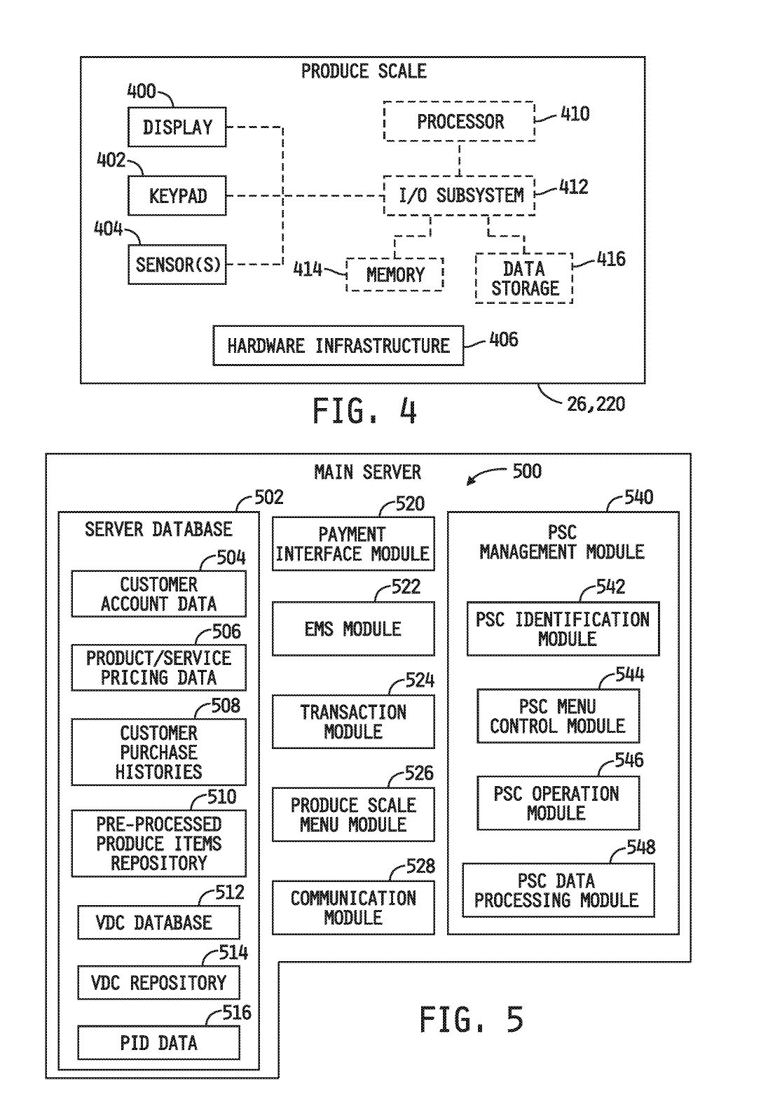

Referring now to FIG. 4, a simplified block diagram is shown of an embodiment of one or more of the produce scales 26₁-26_{N}, 220 illustrated in FIGS. 1 and 2. In the embodiment illustrated in FIG. 4, a representative produce scale 26, 220 illustratively includes at least a display 400, e.g., in the form of a conventional display screen or monitor, one or more sensors 404, e.g., including one or more conventional weight sensors, and conventional hardware infrastructure 406, e.g., including a housing and at least one weight-bearing plate, table, tray or platform upon which produce items to be weighed are placed. In some embodiments, the display 400 is a touch-screen display capable of receiving manual selection of one or more displayed graphical elements such as graphical keypad elements, one or more selectable graphical icons or the like. In embodiments in which the display 400 is not a touch-screen display, the produce scale 26, 220 may further include a conventional hardware keypad.

In some embodiments, one or more of the produce scales 26, 220 is/are controlled entirely by the main server 12 and/or one of the local hub servers 22₁-22_{L} to which the produce scale 26, 220 may be coupled and/or one of the point-of-sale systems 24₁-24_{M} to which the produce scale 26, 220 may be coupled. In some such embodiments, the processor 50 of the main server 12, the processor 30 of a corresponding local hub server 22 and/or the processor 200 of a corresponding point-of-sale system 24 is/are operable to control the entirety of the operation of the produce scale 26, 220. In some alternate embodiments, one or more of the produce scales 26, 220 may include components similar to the main server 12 and also to the one or more local hub servers 22₁-22_{L} and the one or more POS systems 24₁-24_{M} such as a processor 410, an I/O subsystem 412, a memory 414 and a data storage device 416 as shown in dashed-line representation in FIG. 4. In some embodiments, each of the foregoing components may be identical to corresponding components of the local hub server 22₁ and/or POS system 24 described above, and a detailed explanation of such components will not be repeated here for brevity. In other embodiments, one or more of the produce scales 26, 220 may be configured differently than the local hub server 22₁ and/or POS system 24 described above.

As will be described in detail hereinafter, a produce menu graphic user interface (GUI) is illustratively displayed on the display 400 of one or more of the produce scales 26, 220. In some embodiments, the processor 50 of the main server 12 is illustratively operable to control display of the produce menu GUIs displayed on one or more of the produce scales 26, 220. In some alternate embodiments, one or more of a processor 30 of a corresponding one of the local hub servers 22, a processor 200 of a corresponding one of the point-of-sale systems 24 and/or the processor 410 of the produce scale 26, 220, in embodiments which include the processor 410, may control, in whole or in part, display of the produce menu GUIs displayed on one or more of the produce scales 26, 220 and/or operation of one or more of the produce scales 26, 220 generally.

### Main Server Environment

Referring now to FIG. 5, a simplified block diagram is shown of an embodiment of an environment 500 of the main server 12 illustrated in FIG. 1. In the embodiment shown in FIG. 5, the environment 500 includes a server database 502 which illustratively includes customer account data 504, product/service and pricing data 506, customer purchase histories 508, a pre-processed produce items repository 510, a virtual discount coupon (VDC) database 512, a VDC repository 514 and PID data 516.

The main server 12 illustratively hosts, manages and maintains an enterprise member or membership services (EMS) program. As used herein, the term “enterprise member services program,” “enterprise membership services program” or “EMS” are interchangeable and refer to one or more services offered by the retail enterprise 11 to customer members thereof. Examples of such services may include, but are not limited to, making available to customer members via the main server 12 one or more virtual discount coupons redeemable by the retail enterprise 11, tracking and maintaining with the server 12 of customer purchase histories, i.e., histories of products and/or services purchased by customer members over time, in a customer purchase history database 314, and the like.

In embodiments in which the server 12 offers via the EMS program virtual discount coupons to customer members, the server database 502 may include a virtual discount coupon repository 514 which contains for each customer member a plurality of virtual discount coupons provided to thereto by the server 12 from a virtual discount coupon database 512, and which identifies for each customer member one or more virtual discount coupons which may be selected or “clipped” by the customer member for automatic redemption via the customer virtual discount coupon repository 514 during subsequent qualifying purchases made via one of the POS systems 24₁-24_{M}. Illustratively, virtual discount coupons stored in the virtual coupon database 512 are, in some embodiments, received from an external source, although in other embodiments the virtual discount coupons stored in the virtual coupon database 512 may alternatively or additionally be generated by the processor 50 of the main server 12. In any case, customer members of the EMS program may redeem such virtual discount coupons stored or identified in the customer's virtual discount coupon repository 514 by presenting such virtual discount coupons at a POS 24₁-24_{M} against the purchase of from the retail enterprise 11 of various goods and/or services.

Customers may elect to participate in such an enterprise membership services (EMS) program offered, managed and maintained by the main server 12 of the retail enterprise 11 by establishing a user account within the customer account database 504. In this regard, the terms “customer membership account” and “EMS account” are interchangeable and refer to a collection of information about a customer member of the EMS program that is stored in the customer account data 504 separately from such collections of information about other customer members of the EMS program. In one embodiment, the customer account data 504 of the server database 502 illustratively has stored therein one or more access codes and profile data for each customer member of the EMS program. As customers join the EMS program, the server 12 establishes an EMS account within the customer account data 504 that is unique to the customer, and assigns to the customer, and/or the customer selects, a unique, corresponding enterprise membership services identification code, EMSID. The EMSID associated with each customer is stored by the server 12 along with the customer's profile data in the customer account data 504, and can be used by the customer member thereafter to access the customer's EMS account.

The term “EMS identification code” or EMSID illustratively refers to at least one collection of letters, symbols and/or numbers that is different for, and therefore unique to, each customer member of the enterprise membership services program. The EMSID of each customer member of the EMS program is used by the server 12 to uniquely identify that customer's EMS account in the customer account data 504 of the server database 502. The EMSID is further illustratively used by the server 12 to access information about that customer stored and maintained by the main server 12 in the customer account data 504, to access for redemption one or more virtual coupons selected or “clipped” by the customer and stored in that customer's virtual discount coupon repository 506 in embodiments which include such virtual discount coupons as part of the EMS program, and to also access and/or update that customer's purchase history stored in the customer purchase history data 508. In one example embodiment, the EMSID for each customer member of the EMS program may include a unique, several-digit access code and a separate and unique, several-digit password, although in other embodiments the EMSID may include more, fewer and/or different codes and/or passwords.

The customer account data 504 illustratively further includes additional information relating to the customer members of the EMS program. Examples of such additional information include, but are not limited to, customer name, customer address, digital image of the customer, communication information (CI) of one or more mobile communication devices 16 carried by the customer, and the like. The communication information, CI, of any customer mobile communication device 16 stored in the customer account data 504 may be or include any information via which another communication device or system may establish wireless communications with that mobile communication device 16. In one example embodiment in which the mobile communication device 16 is a mobile phone, the communication information (CI) may be or include the telephone number of the customer's mobile phone 16. In other embodiments, the communication information (CI) may be or include a serial number, electronic identification code or other communication identifier associated with the customer's mobile communication device 16 via which another communication device or system may establish wireless communications with that mobile communication device 16. In any case, all such customer information for each customer member is illustratively associated, i.e., linked or mapped together, in the customer account data 504 such that a search by the server 12 of one customer-specific parameter will provide access to the other customer parameters linked thereto in the customer account data 504. Likewise, the purchase history stored in the customer purchase history data 508 for each customer member of the EMS program is linked or mapped to that customer member's information stored in the customer account data 504 such that a search by the server 12 of any customer-specific parameter in the customer account data 504 will link, and therefore provide access, to that customer's purchase history stored in the customer purchase history data 508 and vice versa.

In some embodiments, the EMSID may be provided on or as part of one or more of a customer ID card, an ID associated with an RFID tag, which RFID tag may be part of NFC communication circuitry 320 of the customer's mobile communication device 16 in embodiments that include such circuitry, a customer's shopping incentive card, or the like. In other embodiments, the EMSID may not be provided in or as part of any tangible form, and may instead be or include one or more easily remembered sequences of numbers, letters, symbols or other characters. In any case, customer members of the EMS program described herein may scan, enter via a keypad or touchscreen or otherwise communicate their EMSID to the server 12 directly or via one of the point-of-sale terminals 24₁-24_{M}. In some embodiments, for example, when a customer member provides the customer's EMSID to one of the point-of-sale system 24₁-24_{M} as part of a purchase transaction (e.g., during the purchase transaction or as part of the process of commencing the purchase transaction), a processor of the point-of-sale system 24₁-24_{M} communicates the EMSID to the main server 12 which identifies the customer via the EMSID and associates that customer with the current purchase transaction being carried out at the corresponding point-of-sale system 24₁-24_{M}. Illustratively, all such purchase transaction data relating to items purchased by such an identified customer during a purchase transaction carried out via one of the point-of-sale system 24₁-24_{M} is stored in the customer's purchase history data 508 where it is associated with the identified customer via the customer's EMSID. Illustratively, the purchase transaction data stored in the customer purchase history data 508 may include, but is not limited to, product/service identification information, product/service pricing, product purchase date and time, total quantity of products purchased, total quantity of identical products purchased, total transaction price, and the like, and purchases made by the customer through the retail enterprise 11 are thus monitored and tracked by the main server 12. It is through the customer's EMSID that the main server 12 also makes virtual discount offers available to the customer and that the customer may redeem virtual discount coupons stored or identified in the customer's virtual discount coupon repository 514 against purchases of products and/or services.

The main server 12 illustratively includes an EMS module 522 configured to control and manage customer EMS accounts and EMS-related activity of customer members of the EMS program. In one embodiment, the EMS module 522 manages and controls a customer-member interface, e.g., a web-based interface, to the EMS program via which customers can access and manage their individual EMS accounts stored in the customer account database 504 and via which customers can select or “clip” virtual discount coupons in the virtual discount coupon database 512 for inclusion or identification in the customer's virtual coupon repository 514. Illustratively, each customer may access their individual (and private from other customer-members) EMS account, i.e., their individual EMS page(s) within the web-based EMS interface, which may be referred to herein as an “EMS website” or “EMS web portal,” by entering that customer's EMSID into a graphic user interface element of the web-based EMS interface. Therein, the customer may establish, access, modify and otherwise manage the customer's EMS account information including, for example, but not limited to, name, address, email address, mobile telephone number, photograph of the customer or the like.

Illustratively, a software application program is available for download from the main server 12 via the public network 14 for customers electing to access the EMS program via their mobile communication device, e.g., one of the mobile communication devices 16₁-16_{J}. Once downloaded and activated, customers can access and manage their EMS account and program features via the network 14 with the software application program executed by a computing device and/or by a mobile communication device 16₁-16_{J} if the latter is equipped with a web browser. Such a software application program is illustratively stored in the EMS module 308 of the customer's mobile communication device 16, as illustrated in FIG. 3A, and is executable by the processor 300 of the customer's mobile communication device 16.

As used herein, a “customer membership account” or “EMS account” may in some cases be an individual account accessible only by an individual person, e.g., an individual customer, and in other cases may be a group or “household” account accessible by each of a plurality of members of a predefined group of persons, e.g., members of a family or household, one or more employees of a business enterprise, etc. The terms “member,” “customer member,” “customer” and “household,” and variants thereof, are used interchangeably in the following description, and such terms should be understood to refer interchangeably to an individual customer or a predefined group of individual customers (referred to herein as a “household”) who shop at and purchase items from the retail enterprise 11, and who are members of an enterprise membership service (EMS) of the type described herein and provided and managed by the retail enterprise 11, i.e., by the server 12. MPERKS®, a virtual customer coupon collection and redemption program offered to customers by Meijer, Inc. of Grand Rapids, Mich., is an example of one such EMS program of the type described herein, although it will be appreciated that any retail enterprise membership service which offers virtual discount coupons and/or other benefits to customer members, and/or which tracks items purchased by customer members during item purchase transactions at point-of-sale systems or terminals may be alternatively be used.

The product/service and pricing data 506 contains information relating to the retail products, including produce items, and services sold by the retail enterprise 11 which the main server 12 serves. Illustratively such information may include, but is not limited to, product/service description information including product/service manufacturer, product/service family or brand, primary product type (e.g., bananas), secondary product type (e.g., organic bananas), etc., product size (e.g., bunch, bundle, individual, carton, 16 oz. package, etc.), product/service pricing information, product/service unit pricing information, current product inventory, ordered product data, product sales history, product/service location within the corresponding retail outlet, and the like. Illustratively, product/service pricing information is linked to product/service identification information via scan codes, e.g., scannable bar codes such as Universal Product Codes (UPC) or the like, such that when items are scanned for purchase, the scan code of each item will identify a particular item at a particular price in the product/service and pricing database 506.

As briefly described above, the customer purchase histories 508 illustratively contain purchase histories for each of the customer-members of the EMS program. As any such customer-member conducts purchase transactions at any of the point-of-sale systems 24₁-24_{M} at any of the brick-and-mortar stores 25₁-25_{L} (and also via one or more web-based or “on-line” purchase interfaces in embodiments in which the retail enterprise 11 includes any such interfaces), and as part of such purchase transactions the customer-member manually enters their EMSID into, or otherwise supplies their EMSID to, the point-of-sale systems 24₁-24_{M}, information about the items purchased in the transaction is automatically collected by the processor 50 and stored in the customer-member's customer purchase history contained in the customer purchase histories 508. Illustratively, the information collected and stored by the processor 50 may include, but is not limited to, item description, item type (e.g., produce, meat, frozen food, clothing, outdoor equipment, sporting goods, etc.), item price, item quantity, date purchased, day (of the week) purchased, and the like. Thus, over time, a customer's purchase history contains a log of all purchases made by the customer from the retail enterprise 11 during which the customer supplied to the purchase interface, e.g., the point-of-sale system 24 or a web-based interface, the customer's EMSID. In one embodiment, the server database 502 includes a plurality of purchase histories 508; one for each of the plurality of customer-members. Alternatively, the server database 502 may include a single customer purchase histories database 508, and each customer-member of the EMS program is provided with a dedicated portion of the customer purchase histories 508; i.e., in which the purchase history for that customer-member will be stored. In any case, the customer purchase histories database 508 is configured to store such purchase transaction data in a manner that provides for the separate tracking and identification of purchases made from the retail enterprise 11 by each customer-member.

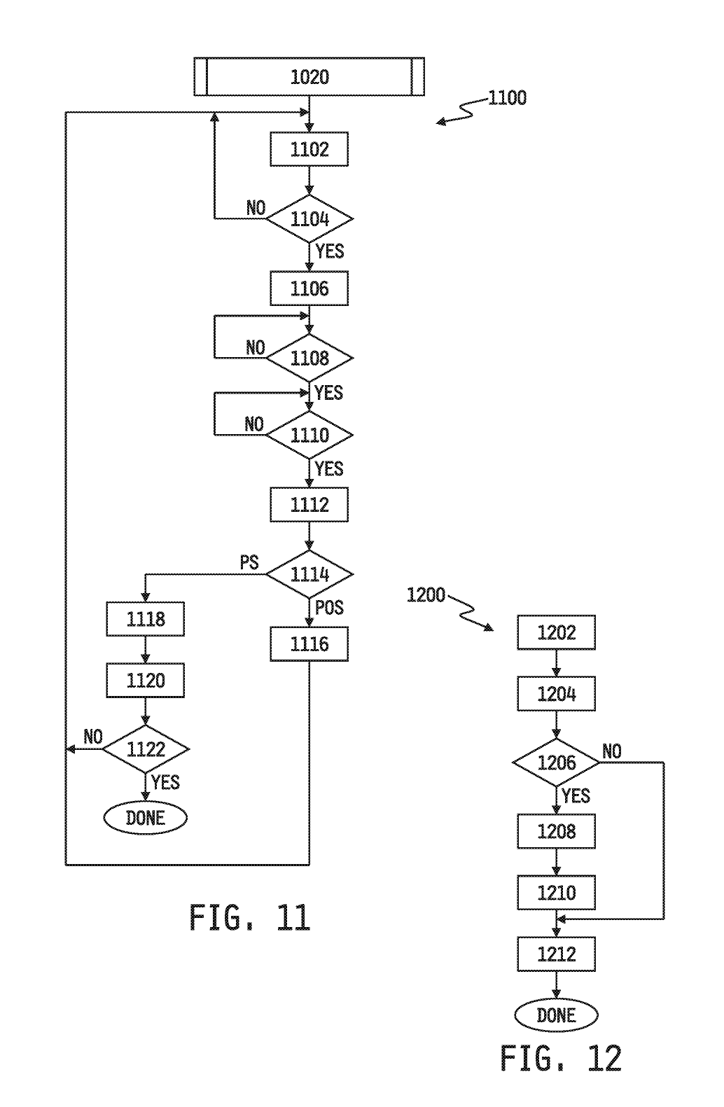

The pre-processed produce items repository 510 illustratively provides for areas or blocks of temporary data storage which may be dynamically established and de-established by the processor 50. In some embodiments, as will be described in greater detail below with respect to the processes illustrated in FIGS. 11 and 12, the processor 50 of the main server is operable in some such embodiments to identify and temporarily assign a storage block or area of the pre-processed produce items repository 510 to an identified customer, e.g., by associating the assigned storage area or block in the pre-processed produce items repository 510 with an identifier of the customer, e.g. CID and/or EMSID. Within any such temporarily assigned storage block or area, the processor 50 may store product and price information for one or more produce items weighed by a customer using one of the produce scales 26₁-26_{N} prior to check out by that customer. Illustratively, the assigned storage area or block in the pre-processed produce items repository 510 may be maintained by the processor 50 until the produce items contained therein are processed by one of the point-of-sales systems 24₁-24_{M}, or after a predetermined amount of time has passed since assigning the storage area or block in the pre-processed produce items repository 520.

The position identification device (PID) data 516, in embodiments which include PID data 516, illustratively has stored therein information from which each position identification device 28₁-28_{P}, 222 in the retail enterprise 11 can be uniquely identified and/or located. In some embodiments, for example, the PID data 516 may include only PID identity information which identifies each particular PID 28₁-28_{P}, 222 and/or which identifies some aspect, property or characteristic thereof. In other embodiments, the PID data 516 may illustratively include PID location information which identifies a location or position of each PID 28₁-28_{P}, 222 geographically and/or relative to one or more references positions. In still other embodiments, the PID data 516 may include a combination of any such PID identity information and PID location information.

In embodiments in which the PID data 516 includes PID identity information, such PID identity information may illustratively include a unique identification code (UID) for each PID 28₁-28_{P}, 222 such that each stored UID value uniquely identifies a different one of the plurality of position identification devices 28₁-28_{P}, 222. Alternatively or additionally, the PID identity information may include information relating to a property or characteristic of one or more of the PIDs 28₁-28_{P}, 222 which distinguishes it/them from others of the PIDs 28₁-28_{P}, 222 (apart from its/their location(s)). Examples of such additional PID identity information may include, but is not limited to, a device type identification code (DTID), a location type identification code (LTID), and the like.

In some embodiments, more than one type of PID may be implemented such that detection techniques used with such types of PIDs differ from detection techniques used with different types of PIDs. In such embodiments, the PID identity information included in the PID data 516 may illustratively include a different device type identification code (DTID) for PIDs 28₁-28_{P}, 222 of each different device type such that each stored DTID value identifies PIDs 28₁-28_{P}, 222 of a common type.

In some embodiments, different PIDs of the same or different type may be implemented at or adjacent to common structures or areas at two or more different locations. Examples include PIDs located at each POS system 24₁-24_{M} in each of a plurality of different brick-and-mortar stores 25₁-25_{L}, PIDs of the same type located at each produce scale 26₁-26_{N} in each of a plurality of different brick-and-mortar stores 25₁-25_{L}, a PID located at an entrance/exit (or one or more entrances/exits) of each of a plurality of different brick-and-mortar stores 25₁-25_{L}, a PID located at a bakery department in each of a plurality of different brick-and-mortar stores 25₁-25_{L}. Each of the foregoing sub-groups of PIDs share a common location type, e.g., POS PIDs, Produce Scale PIDs, Store entrance PIDs and bakery PIDs respectively, and in such embodiments, the PID identity information included in the PID data 516 may illustratively include location type identification code (LTID) for PIDs 28₁-28_{P}, 222 located at common locations such that each stored LTID value identifies PIDs 28₁-28_{P}, 222 of implemented at common locations.

In embodiments in which the PID data 516 includes PID location information, such PID location information may illustratively include information which associates a location or position of one or more PIDs 28₁-28_{P}, 222 with a geographic location or position and/or with a location or position relative to a reference or known position or location. Examples of such PID location information may include, but are not limited to, a store identification code (SID), a department identification code (DID), a product identification code (PRID) and a specific location identification code (LID).

In some embodiments, multiple PIDs 28₁-28_{P}, 222 may be implemented at each of a number of geographically separate brick-and-mortar stores 25₁-25_{L}. In such embodiments PID location information may include a store identification code (SID) for each PID 28₁-28_{P}, 222 that identifies the one of the plurality of stores 25₁-25_{L} in or at which that PID 28₁-28_{P}, 222 is implemented, such that a group of all PIDs 28₁-28_{P}, 222 at a common location, i.e., implemented in or at the same store, share the same SID but that groups of PIDs implemented in or at different stores have different SIDs. Similarly, in some embodiments multiple PIDs 28₁-28_{P}, 222 may be implemented in or at each of a number of different departments within a brick-and-mortar store 25. In such embodiments, PID location information may accordingly include a department identification code (DID) for each PID 28₁-28_{P}, 222 that identifies the one of a plurality of departments in or at which that PID 28₁-28_{P}, 222 is implemented, such that a group of all PIDs 28₁-28_{P}, 222 implemented in or at the same department share the same DID but that groups of PIDs implemented in or at different departments within the same store or in different stores have different DIDs. Likewise, in some embodiments multiple PIDs 28₁-28_{P}, 222 may be implemented at or near each of a number of different products or product areas within a department and/or within a brick-and-mortar store 25. In such embodiments, PID location information may include a product identification code (PRID) for each PID 28₁-28_{P}, 222 that identifies the one of a plurality of different products or product areas within a department and/or within a store stores 25₁-25_{L} at or near which that PID 28₁-28_{P}, 222 is implemented, such that a group of all PIDs 28₁-28_{P}, 222 implemented at or near a set of like products or product areas share the same PRID but that groups of PIDs 28₁-28_{P}, 222 implemented at or near different sets of like products or product areas have different PRIDs. Finally, in some embodiments, one or more PIDs 28₁-28_{P}, 222 may be implemented in or at specific or random locations within one or more areas of, or throughout, a brick-and-mortar store 25, and in such embodiments PID location information may include a specific location identification code (LID) for each PID 28₁-28_{P}, 222 that identifies a specific location, e.g., absolute or relative to one or more other known positions or locations, at or near which that PID 28₁-28_{P}, 222 is implemented, such that each PID 28₁-28_{P}, 222 has a different LID.

In embodiments in which the PID data 516 includes multiple PID identity codes and/or multiple PID location codes for one or more of the PIDs 28₁-28_{P}, 222, such multiple PID identity codes and/or multiple PID location codes for each PID 28₁-28_{P}, 222 are associated with each other, e.g., linked together, in the PID data 516. Accordingly a search of the PID data 516 for information relating to any one of the PIDs 28₁-28_{P}, 222 will produce all PID identity code and/or multiple PID codes stored in the PID data 516 for that PID 28₁-28_{P}, 222. Those skilled in the art will recognize other information that may be included in the PID data 516 from which the identity and/or location of one or more of the PIDs 28₁-28_{P}, 222 may be determined, and it will be understood that any such other information and any technique for processing any such information to determine the identity/identities of one or more of the PIDs 28₁-28_{P}, 222 and/or the location(s) of one or more of the PIDs 28₁-28_{P}, 222 is contemplated by this disclosure.

In some embodiments, the PID data 510 may further include store location data, e.g., in the form of reference location information identifying each of the brick-and-mortar stores 25₁-25_{L} of the retail enterprise and a geographic location thereof. In some embodiments, the store location data may include various physical locations within each brick-and-mortar store 25. In some embodiments, the store location data may alternatively or additionally include physical and/or product location information identifying various departments, merchandise areas, product display areas, shelving units, shelves or other physical locations within the brick-and-mortar stores. In still other embodiments, the store location data may alternatively or additionally include topographical map, planogram or other such data, some or all of which may be in graphical form, corresponding to one or more locations or areas within each of the brick-and-mortar stores 25₁-25_{L}.

The environment 500 of the main server 12 further includes a payment interface module 520, a transaction module 324, a produce scale menu module 526 and a communication module 526. In one embodiment, the payment interface module 520 is configured, in a conventional manner, to process tangible forms of electronic payment systems (EPS), e.g., tangible electronic funds transfer instruments such as credit cards, debit cards, etc., used at the point-of-sale systems 24₁-24_{M}. In an example of such embodiments, the payment interface module 520 illustratively is or includes a conventional magnetic strip reading device configured to read payment information stored in magnetic form on a strip affixed to a conventional credit or debit card. Alternatively or additionally, the payment interface module 520 may be or include an NFC interface, and in such embodiments the NFC interface is configured to access, via contact or near-contact with a mobile communication device 16 having a like-configured NFC device 320, electronically readable customer payment system (EPS) information stored on or accessible by the mobile electronic device 16.

The transaction module 524 is configured to monitor and manage transactions for the purchase of products and services made by customers using any of the point-of-sale systems 24₁-24_{M}. The communication module 528 is configured, in a conventional manner, to control and manage all communications between the main server 12 and the local hub servers 22 in embodiments that include the local hub servers 22, and to control and manage all communications between the main server 12 and all point-of-sale systems 24₁-24_{M}, in embodiments that do not include a local hub server 22. The communication module 528 is further configured, in a conventional manner, to control and manage all wireless communications conducted between the main server 12 and the mobile communication devices 16₁-16_{J}, and between the main server 12 and the user computing devices 18₁-18_{K}.

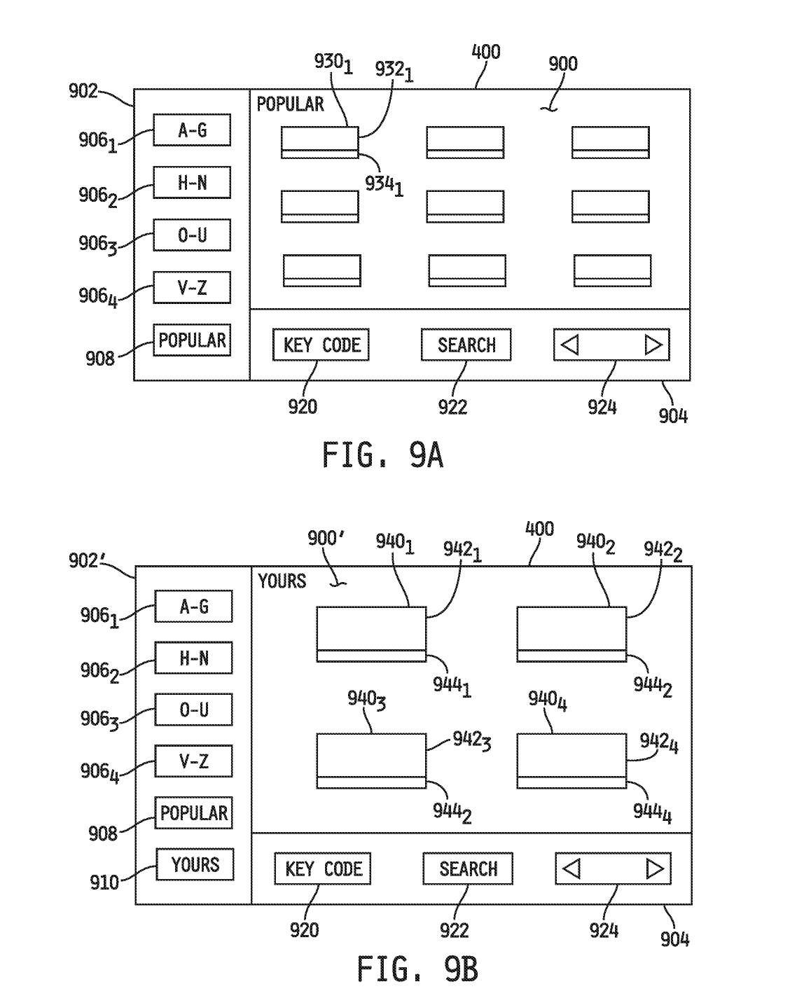

The produce scale menu module 526 illustratively has stored therein instructions executable by the processor 50 to control the displays 400 of the produce scales 26₁-26_{N}, 220 to display a produce scale GUI thereon. In some alternative embodiments, the processor 50 may process the produce scale GUI instructions stored in the produce scale menu module 526 and transmit one or more signals to one or more of the local servers 22₁-22_{L}, one or more of the point-of-sale systems 24₁-24_{M} or one or more of the produce scales 26₁-26_{N} instructing the corresponding processor(s) 30, 200 or 410 to control the display 400 of a corresponding produce scale 26₁-26_{N}, 220 to display the produce scale GUI thereon. In still other alternative embodiments, the produce scale GUI instructions may be executed, in whole or in part, by one or more of the processors 30, 200 and/or 410. In any case, one or more of the processors 50, 30, 200 and/or 410 is/are operable to execute the produce scale GUI instructions stored in the produce scale menu module 526 to control the display(s) 400 of one or more of the produce scales 26₁-26_{N}, 220 to display the produce scale GUI thereon. For purposes of this disclosure, the produce scale GUI instructions stored in the produce scale menu module 526 will be described as being executed by the processor 50, although it will be understood that such instructions may alternatively or additionally be executed by one or more other processors as just described. An example produce menu GUI is depicted in FIG. 9A, and will be described in detail hereinafter.

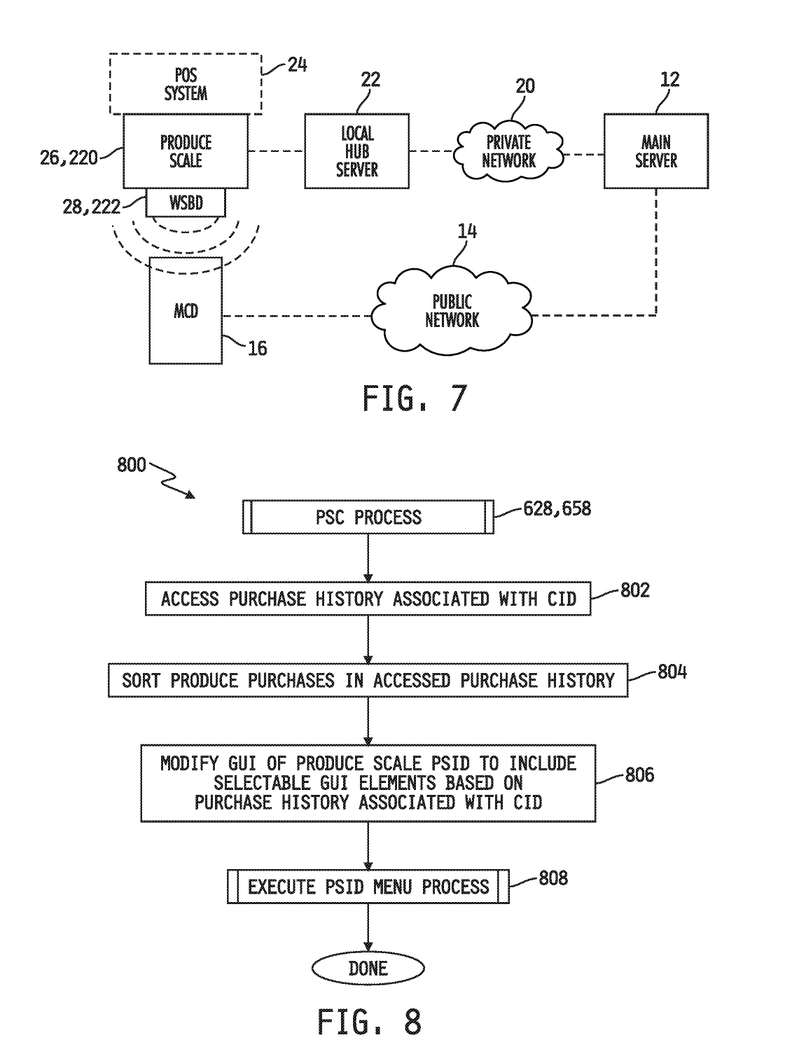

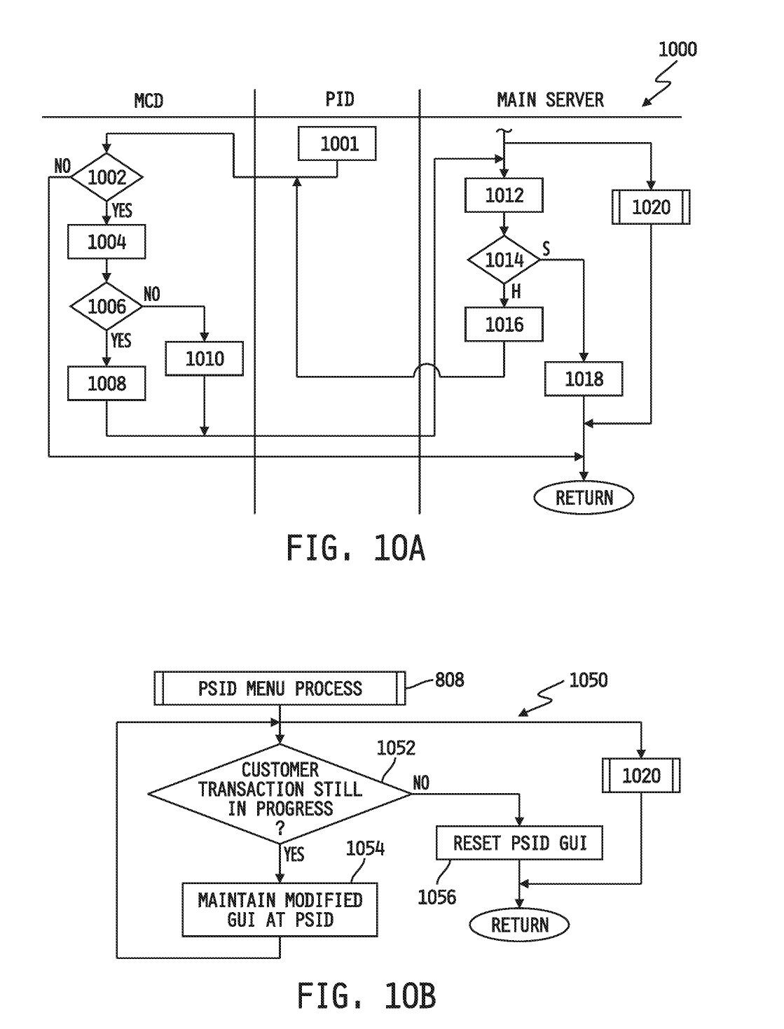

The environment 500 of the main server 12 further illustratively includes a produce scale (PSC) management module 540 which illustratively includes a (PSC) identification module 542, a PSC menu control module 544, a PSC operation module 546 and a PSC data processing module 548. The PSC identification module 542 is illustratively operable to manage and control identification of customer mobile communication devices 16₁-16_{J} and of produce scales 26₁-26_{N}, 220 relative to the PIDs 28₁-28_{P}, 222. Example embodiments of processes executed by the PSC identification module 542 are illustrated in FIGS. 6A, 10A and 12, and such processes will be described in detail hereinafter. The PSC menu control module 544 is illustratively operable to manage and implement modifications made to produce menu GUIs of the produce scales 26₁-26_{N}, 220. Example embodiments of processes executed by the PSC module 544 are illustrated in FIGS. 8 and 9B, and such processes will be described in detail hereinafter. The PSC operation module 546 is illustratively operable to manage and control operation of the produce scales 26₁-26_{N}, 220 to maintain modification the produce menu GUIs during customer use thereof. Example embodiments of processes executed by the PSC operation module 546 are illustrated in FIGS. 10A and 10B, and such processes will be described in detail hereinafter. The PSC data processing module 548 is illustratively operable to manage and control tracking of produce items processed by customers at produce scales 26₁-26_{N} prior to checkout, and to further manage and control processing of such produce items during subsequent purchase transactions at one of the point-of-sale systems 24₁-24_{M}. Example embodiments of processes executed by the PSC data processing module 548 are illustrated in FIGS. 11 and 12, and such processes will be described in detail hereinafter.

### Produce Scale and Mobile Communication Device ID Process(es)

Referring now to FIG. 7, a simplified block diagram is shown of an illustrative example of a portion of the system 10 of FIG. 1 implemented in one of the brick-and-mortar stores 25₁-25_{L} of the retail enterprise 11. For purposes of the following description, the PIDs 28₁-28_{P}, 424, the position identification devices 28₁-28_{P}, 220 are illustratively provided in the form of conventional electronic wireless signal broadcasting devices 28₁-28_{P}, 220, e.g., conventional radio frequency broadcasting beacons, for the purpose of broadcasting radio signals carrying information corresponding to the location and/or identity thereof, and will be described in the remainder of this document as such. It will be understood, however, that this disclosure contemplates other embodiments in which one or more of the position identification devices 28₁-28_{P}, 220 is/are provided in another form. Examples of such other forms will be described at the end of this document.

The example depicted in FIG. 7 illustrates a communications framework for detecting by customer mobile communication devices 16₁-16_{J} of wireless identification signals broadcast by any of the PIDs 28₁-28_{P} associated with, i.e., located at, on or near, one of the produce scales 26₁-26_{N} or by a PID 222 associated with, i.e., located at, on, or near, any of the point-of-sale systems 24₁-24_{M} within any of the brick-and-mortar stores 25₁-25_{L} of the retail enterprise 11, and for conducting wireless communications relating thereto between the customer mobile communication devices 16₁-16_{J} and the main server 12 of the retail enterprise 11. In the illustrated embodiment, a produce scale is shown coupled to the local hub server 22, and the local hub server 22 is coupled to the main server 12 via the private network 20 as illustrated and described with respect to FIG. 1. The produce scale depicted in FIG. 7 may illustratively represent any of the one or more produce scales 26₁-26_{N} located in one of the brick-and-mortar stores 25₁-25_{L} remotely from, or at least not part of or associated with any of, the point-of-sale systems 24₁-24_{M}, e.g., located in or near a produce section or department of a brick-and-mortar store 25. In some such embodiments which do not include the local hub server 22, the produce scale 26 may be coupled directly to the main server 12 via the private network 20. Alternatively or additionally, the produce scale depicted in FIG. 7 may illustratively represent a produce scale 220 associated with any of the one or more point-of-sale systems 24₁-24_{M}, and in such embodiments the produce scale 220 is mounted to, mounted adjacent to, integral with or otherwise part of a corresponding point-of-sale system 24 as shown by dashed-line representation in FIG. 7. In some such embodiments, the produce scale 220 may be coupled to the point-of-sale system 24 and the point of sale system 24 may be coupled to the local hub server 22 as illustrated in FIG. 1. In other embodiments, such as in embodiments which do not include the local hub server 22, the produce scale 220 and/or the point-of-sale system 24 may be coupled directly to the main server 12 via the private network 20.

Associated with the produce scale 26 or 220, as illustrated in FIG. 7, is at least one wireless signal broadcasting device 28 or 222 respectively, which may be mounted to, at or near the corresponding produce scale 26 or point-of-sale system 24. As the communication framework depicted in FIG. 7 relates to any of the wireless signal broadcasting devices 28₁-28_{P}, for example, any such wireless signal broadcasting device 28 is illustratively positioned at, near or above the corresponding produce scale 26 or anywhere sufficiently proximate to the produce scale 26 such that a mobile communication device 16 carried by a customer using the produce scale 26 will be able to detect wireless signals broadcast by the wireless signal broadcasting device 28, i.e., such that the wireless signal broadcasting device 28 will be in-range relative to the customer's mobile communication device 16 as the term “in-range” is defined below. As the communication framework depicted in FIG. 7 relates to a wireless signal broadcasting device 222 associated with any of the point-of-sale systems 24₁-24_{M}, any such wireless signal broadcasting device 222 is illustratively positioned at, on, in, adjacent to or above the corresponding point-of-sale system 24₁-24_{M} or anywhere sufficiently proximate to the produce scale 220 such that a mobile communication device 16 carried by a customer using the produce scale 220 and/or conducting a purchase transaction at the corresponding point-of-sale system 24₁-24_{M} will be able to detect wireless signals broadcast by the wireless signal broadcasting device 222, i.e., such that the wireless signal broadcasting device 222 will be in-range relative to the customer's mobile communication device 16.

As described hereinabove with respect to FIG. 1, each wireless signal broadcasting device 28₁-28_{P}, 222 is operable to broadcast wireless identification signals. Each wireless signal broadcasting device 28₁-28_{P}, 222 is further illustratively configured to broadcast wireless identification signals with a predefined orientation (i.e., direction) and broadcast range. In the example illustrated in FIG. 7, the wireless signal broadcasting device 28, 222 is illustratively configured and operable to broadcast wireless identification signals directionally away from the produce scale 26, 220 and/or point-of-sale system 24 as indicated in FIG. 7 by the dashed-line open rings emanating from the wireless signal broadcasting device 28, 222. In some embodiments, any of the wireless signal broadcasting devices 28₁-28_{P}, 222 may alternatively be configured and operable to broadcast wireless identification signals concentrically thereabout. Those skilled in the art will recognize that any of the wireless signal broadcasting devices 28₁-28_{P} and/or any of the wireless signal broadcasting devices 222 may alternatively still be configured and operable to broadcast wireless identification signals in any desired direction relative to the wireless signal broadcasting device and/or with any desired orientation, and it will be understood that any such alternative wireless identification signal broadcast direction and/or orientation is/are contemplated by this disclosure.

Each wireless signal broadcasting device 28₁-28_{P}, 222 is further illustratively configured to broadcast a wireless identification signal with a predefined broadcast range. Generally, the broadcast range of any wireless signal broadcasting device 28₁-28_{P}, 222 illustrated and described herein should be understood to be defined by an area relative to that wireless signal broadcasting device 28₁-28_{P}, 222 within which the signal strength of wireless signals broadcast thereby is sufficient to be detected by the communication circuitry 316 of the customer mobile communication devices 16₁-16_{J}, and outside of which the signal strength of wireless signals broadcast thereby is undetectable by the communication circuitry 316 of the customer mobile communication devices 16₁-16_{J}. As used in the previous sentence, the term “undetectable” should be understood to mean any of indistinguishable by the communication circuitry 316 of the customer mobile communication devices 16₁-16_{J} from background electromagnetic noise, distinguishable by the communication circuitry 316 of the customer mobile communication devices 16₁-16_{J} from background electromagnetic noise but not decodable by the communication circuitry 316 of the customer mobile communication devices 16₁-16_{J} or distinguishable by the communication circuitry 316 of the customer mobile communication devices 16₁-16_{J} from background electromagnetic noise but not decodable by communication circuitry of any electronic device or system to which the communication circuitry 316 of the customer mobile communication devices 16₁-16_{J} may transmit or otherwise relay the wireless broadcast signal(s).

As described hereinabove with respect to FIG. 1, each of the wireless signal broadcasting devices 28₁-28_{P}, 222 is illustratively operable to broadcast one or more unique wireless identification signals which distinguish each particular wireless signal broadcasting device 28₁-28_{P}, 22 from others of the wireless signal broadcasting devices 28₁-28_{P}, 222 located at the same brick-and-mortar store 25₁-25_{L}, and in other embodiments also from all others of the wireless signal broadcasting devices 28₁-28_{P}, 222 within the retail enterprise 11. At some point, while the wireless signal broadcasting devices 28₁-28_{P}, 222 are broadcasting one or more unique wireless identification signals, a customer carrying the customer's mobile communication device 16 may approach a location at which a wireless signal broadcasting device 28₁-28_{P}, 222 is positioned. This scenario is illustrated in FIG. 7 in which the customer's mobile communication device 16 is shown adjacent to the wireless signal broadcasting device 28, 222. The customer's mobile electronic device 16 and the main server 12 are each illustratively configured to communicate wirelessly with each other via the public network 14 as also shown in FIG. 7, and in some embodiments the brick-and-mortar store 25₁-25_{L} may illustratively implement one or more local or wide area networks for the purpose of providing or enhancing wireless communication access by customer mobile communication devices 16₁-16_{J} to the public network 14.

In any case, as the mobile communication device 16 carried by the customer approaches the wireless signal broadcasting device 28, 222, the customer's mobile communication device 16 enters a space that is within the broadcast range of the wireless signal broadcasting device 28, 222 as illustrated in FIG. 7, and when within the broadcast range of the wireless signal broadcasting device 28, 222 the customer's mobile communication device 16 is able to detect the unique identification signals being broadcast thereby. Illustratively, the broadcast range of the wireless signal broadcasting device 28, 222 is sufficiently large, wide and/or oriented so as to be detectable by customers' mobile communication devices 16₁-16_{J} when customers carrying such mobile communication devices 16₁-16_{J} use the produce scale 26 or the produce scale 220 and/or when conducting a purchase transaction at the corresponding point-of-sale system 24. Further illustratively, the broadcast range of the wireless signal broadcasting device 28, 222 is, at the same time, sufficiently small, narrow and/or oriented so as to provide a desired amount or degree of resolution in determining the location of a customer's mobile communication device 16 relative to the wireless signal broadcasting device 28, 222 and/or relative to the point-of-sale system 24. The general communication framework depicted in FIG. 7 is illustratively used in the process 600 illustrated and described below with reference to FIG. 6 for detecting by customer mobile communication devices 16₁-16_{J} of wireless identification signals broadcast by at least one wireless signal broadcasting device 28 located at or near at least one of the produce scales 26₁-26_{N} and/or for detecting by customer mobile communication devices 16₁-16_{J} of wireless identification signals broadcast by at least one of the wireless signal broadcasting devices 24₁-24_{M} located at or near with at least one at least one of the point-of-sale systems 24₁-24_{M} which include a produce scale 222, and in either case also for conducting wireless communications between such customer mobile communication devices 16₁-16_{J} and the main server 12 of the retail enterprise

Referring now to FIG. 6A, a simplified flow diagram is shown depicting an embodiment of a process 600 for identifying customers and produce scales 26₁-26_{N} at brick-and-mortar stores 25₁-25_{L} of the retail enterprise 11. As indicated by the framework of the process 600 illustrated in FIG. 6A, a portion of the process 600, i.e., the portion to the left of the left-most vertical line and centered under the heading “MCD,” illustratively represents one or more software applications executed by the processor 300 of a customer's mobile communication device 16, i.e., one of the mobile communication devices 16₁-16_{J} associated with a customer of the retail enterprise 11. In one embodiment, this portion of the process 600 is or includes the produce scale control (PSC) application module 310 stored in the memory 304 (and/or data storage 306) of the customer's mobile communication device 16 (see FIG. 3A) in the form of instructions executable by the processor 300 of the customer's mobile communication device 16. The process steps of this portion of the process 600 will be described below for purposes of this disclosure as being executed by the processor 300 of the customer's mobile communication device 16.

Another portion of the process 600, i.e., the portion between the left-most vertical line and the right-most vertical line in FIG. 6A, and centered under the heading “Wireless signal broadcasting device,” does not necessarily represent a portion of the process 600 that is stored in a memory of any system or server in the form of instructions executable by a processor, but rather represents operation of the various wireless signal broadcasting devices 28₁-28_{P} and/or 222 illustrated and described with respect to FIGS. 1 and 7 as such operation relates to the broadcast of wireless identification signals as described hereinabove.

Yet another portion of the process 600, i.e., the portion to the right of the right-most vertical in FIG. 6A, and centered under the heading “Main Server,” illustratively represents one or more software applications executed by the processor 50 of the main server 12. In one embodiment, this portion of the process 600 is stored in one or more of the modules stored in the produce scale control (PSC) management module 540 (see FIG. 5), e.g., in the produce scale control module 542 and/or wireless signal broadcasting device module 544, in the form of instructions executable by the processor 50 of the main server 12. The process steps of this portion of the process 600 will be described below for purposes of this disclosure as being executed by the processor 50 of the main server 12. In some alternate embodiments, e.g., that may or may not include a main server 12, this portion of the process 600 may alternatively be stored in the memory 34 (and/or data storage 36) of one or more of the local servers 22₁-22_{L} in the form of instructions executable by the processor 30 of the one or more local servers 22₁-22_{L}, stored in the memory of one of the point-of-sale systems 24₁-24_{M} within one or more of the brick-and-mortar enterprise stores 25₁-25_{L} in the form of instructions executable by a processor 200 associated with any such point-of-sale system 24₁-24_{M} and/or stored in a memory and executable by a processor of another system external to or supplemental to the system 10 illustrated FIG. 1. It will further be understood that portions of the process 600 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

In the process 600 illustrated in FIG. 6, item 602 illustratively identifies action taken by one or more of the plurality of wireless signal broadcasting devices 28₁-28_{P} positioned at, in, or near one or more sections or product/service departments in any of the brick-and-mortar stores 25₁-25_{L} of the retail enterprise 11 such as, for example, a produce section or department, and/or action taken by a wireless signal broadcasting device 222 associated with any of the plurality of point-of-sale systems 24₁-24_{M} at any of the brick-and-mortar stores 25₁-25_{L} with which a produce scale 220 is co-located. In some embodiments, each such one or more wireless signal broadcasting devices 28₁-28_{P} and/or 222 operate to continuously or continually broadcast wireless identification signals, each of which carry decodable information in the form of a unique identification code (UID) as described hereinabove with respect to FIG. 1. In some embodiments, such signals may be periodically or non-periodically broadcast by the one or more wireless signal broadcasting devices 28₁-28_{P}, 222 and in other embodiments some such wireless signal broadcasting devices may periodically broadcast wireless signals and others of the wireless signal broadcasting devices may broadcast wireless signals non-periodically. In still other embodiments, one or more such wireless signal broadcasting devices may sometimes periodically broadcast wireless signals and at other times broadcast wireless signals non-periodically. In any case in embodiments in which such wireless signal broadcasting devices continuously or continually broadcast wireless signals, the process advances to step 604 where the wireless communication circuitry 316 of the customer's mobile communication device 16 is illustratively operable to detect any such broadcast wireless identification signals within the broadcast range of which the mobile communication device 16 is located as described above with respect to FIG. 7.

In some alternative embodiments, one or more wireless signal broadcasting devices 28₁-28_{P} and/or 222 may be selectively operable to periodically or non-periodically broadcast wireless identification signals. In such embodiments, one or more such wireless signal broadcasting devices may, for example, be responsive to one or more control signals produced by the processor 50 of the main server, the processor 30 of one of the local hub servers 22₁-22_{L}, a processor 200 associated with one or more of the point-of-sale systems 24₁-24_{M} located in the brick-and-mortar store and/or other processor(s) associated with the one or more other devices and/or systems within the brick-and-mortar store or the retail enterprise 11, to selectively wake up or otherwise activate and begin broadcasting wireless identification signals, and to selectively deactivate and cease broadcasting wireless signals. In some embodiments, the brick-and-mortar store may include a plurality of conventional proximity or motion-detecting sensors, e.g., one or more such sensors at or near one or more of the wireless signal broadcasting devices 28₁-28_{P} and/or 222 and production of such control signals may be triggered by proximity or motion signals produced by such sensors. In other embodiments, production of such control signals may, for example, be triggered by the processor 50, e.g., in response to certain operating hours of one or more of the brick-and-mortar stores or outlets of the retail enterprise 11. Those skilled in the art will recognize that any modifications required to implement and integrate one or more steps of any such alternate embodiment into the process 600 would be a mechanical step for a skilled programmer, and that such alternate embodiments therefore fall within the scope of this disclosure.

As used hereinafter, the term “in-range” will be understood to refer to any of the wireless signal broadcasting devices 28₁-28_{P} and/or 222 within the broadcast range of which a customer's mobile communication device 16 is presently located. Thus, in the example illustrated in FIG. 7 the customer carrying the mobile communication device 16 is within the broadcast range of the wireless signal broadcasting device 28, 222 as illustrated by the dashed-line wireless identification signals in contact with the device 16, and in this example the wireless signal broadcasting device 28, 222 is an in-range wireless signal broadcasting device relative to the customer mobile communication device 16.

Referring again to FIG. 6A, the processor 300 of the customer's mobile communication device 16 is operable at step 604 to detect unique identification signals wirelessly broadcast by any in-range one(s) of the plurality of wireless signal broadcasting devices 28₁-28_{P} and/or 222 at the time of execution of step 604. Following step 604, the process 600 advances to step 606 where the processor 300 of the customer's mobile communication device 16 is responsive to detection of wireless identification signals broadcast by any in-range wireless signal broadcasting device 28₁-28_{P} and/or 222 to wake up and activate the PSC application 310 stored in the memory 304 or data storage 306 of the mobile communication device 16. Thereafter at step 608, the processor 300 is operable in one embodiment to transmit one or more wireless signals to the main server 12, e.g., to control the communication circuitry 316 in the device 16 to wirelessly transmit one or more signals to the main server 12 via the public network 14. The one or more wireless signals illustratively contain(s) the unique identification (UID) of an in-range wireless signal broadcasting device as well as communication information, CI, which identifies the mobile communication device 16 for purposes of wirelessly communicating therewith, e.g., a mobile telephone number and/or other communication identifier which identifies the customer's mobile communication device 16 to the main server 12 for the purpose of communicating information from the main server 12 back to the customer's mobile communication device 16.

In one embodiment, the processor 300 of the customer's mobile communication device 16 is operable at step 606 to process the wireless identification signals broadcast by an in-range one of the wireless signal broadcasting devices to determine therefrom the UID of the in-range wireless signal broadcasting device, and to include the UID thereof in the one or more wireless signals transmitted by the customer's mobile communication device 16 to the main server 12 at step 608. In other embodiments, the processor 300 may be operable at step 606 to include in the one or more wireless signals transmitted by the customer's mobile communication device 16 to the main server 12 at step 608 only the raw signal content of the detected wireless identification signals. In such embodiments, the processor 50 of the main server 12 may be operable to thereafter process the raw signal content transmitted thereto by the customer's mobile communication device 16 to determine therefrom the UID of a corresponding in-range wireless signal broadcasting device.

Following step 608, the main server 12 is operable at step 610 to receive the one or more wireless signals transmitted by the customer's mobile communication device 16 at step 608, and the processor 50 of the main server 12 is thereafter operable at step 612 to process the UID contained therein to determine the identity of the in-range one of the wireless signal broadcasting devices whose wirelessly broadcast identification signals were detected by the customer's mobile communication device 16 at step 604, and to determine the type and/or location of the detected wireless signal broadcasting device. The wireless signal broadcasting device type may be, for example, a particular type of wireless signal broadcasting device as between multiple possible wireless signal broadcasting device types, and the wireless signal broadcasting device location may be, for example, the location of the brick-and-mortar store 25₁-25_{L} in which the detected wireless signal broadcasting device is located and/or the location of the detected wireless signal broadcasting device relative to a particular structure or location within a particular brick-and-mortar store 25₁-25_{L}.

As described briefly above with respect to FIG. 5, the wireless signal broadcasting device module 544 illustratively has stored therein wireless signal broadcasting device identity information for each wireless signal broadcasting device in the retail enterprise 11, and such wireless signal broadcasting device identity information illustratively includes information from which the processor 50 can determine, for each such wireless signal broadcasting device, the wireless signal broadcasting device type, the identity of the brick-and-mortar store 25₁-25_{L} at which each such wireless signal broadcasting device is located, and/or the relative location or position of that wireless signal broadcasting device within an identified brick-and-mortar store 25₁-25_{L}. Illustratively, the wireless signal broadcasting device identity information stored in the wireless signal broadcasting device module 544 includes at least the UIDs for each of the wireless signal broadcasting devices in the retail enterprise 11. In some embodiments, each such UID may further include or be associated with, e.g., linked to, mapped to, or otherwise identified in the wireless signal broadcasting device module 544 with, a wireless signal broadcasting device type identifier (BT), e.g., in the form of a designation code or other identifier which identifies the type of the corresponding wireless signal broadcasting device. The wireless signal broadcasting device type identifiers, BT, in embodiments which include wireless signal broadcasting device type identifiers, are illustratively stored in the form of wireless signal broadcasting device type codes, each of which illustratively identify the wireless signal broadcasting device type by a general location or type of location for wireless signal broadcasting devices of common type or by a particular use of wireless signal broadcasting devices of common type. Examples of wireless signal broadcasting device type codes may include, for example, “POS” which illustratively identifies wireless signal broadcasting devices 222 used with and located at one or more of the point-of-sale systems 24₁-24_{M}, “PS” which illustratively identifies wireless signal broadcasting devices 28₁-28_{P} used and located at or near one or more of the produce scales 26₁-26_{N} implemented in any of the brick-and-mortar stores 26₁-26_{N}, “SE” which may illustratively identify wireless signal broadcasting devices used at and located in or at customer entry areas to brick-and-mortar stores of the retail enterprise, and the like. Those skilled in the art will recognize other uses and/or locations where one or more wireless signal broadcasting devices may be positioned and other corresponding codes that may be used to identify such wireless signal broadcasting device types, and it will be understood that any such other wireless signal broadcasting device uses/locations and associated wireless signal broadcasting device type codes are contemplated by this disclosure.

In some embodiments, each such UID may alternatively or additionally include or be associated with, e.g., linked to, mapped to, or otherwise identified in the wireless signal broadcasting device module 544 with, a brick-and-mortar store identifier (BMID), e.g., in the form of a designation number or code, which identifies the corresponding one of the brick-and-mortar stores 25₁-25_{L} of the retail enterprise in which the corresponding wireless signal broadcasting device is located. The brick-and-mortar location identifiers, BMID, in embodiments which include such brick-and-mortar store identifiers, are illustratively stored in the form of store numbers or codes, such as store 8 or store S4. In other embodiments, the brick-and-mortar location identifiers may include additional information such as city, state or country identifier or the like. Those skilled in the art will recognize other techniques and/or codes that may be used to identify such brick-and-mortar locations where particular wireless signal broadcasting devices are located, and it will be understood that any such other techniques and/or codes are contemplated by this disclosure

In some embodiments, each such UID may alternatively or additionally still include or be associated with, e.g., linked to, mapped to, or otherwise identified in the wireless signal broadcasting device module 544 with, e.g., linked to, mapped to or otherwise identified with, a wireless signal broadcasting device location identifier (BID), e.g., in the form of a designation code or other identifier which identifies a location or position of the corresponding wireless signal broadcasting device relative to a reference position and/or structure within all brick-and-mortar stores 25₁-25L, e.g., in embodiments in which all such brick-and-mortar stores 25₁-25_{L} are identically configured, or which identifies a location or position of the corresponding wireless signal broadcasting device relative to a reference position and/or structure within a particular one of the brick-and-mortar enterprise stores 25₁-25_{L}. In some embodiments of the latter case, the BID may include one or more codes or other identifiers which identify both the particular one of the brick-and-mortar stores 25₁-25_{L} in which the wireless signal broadcasting device in located and a location or position within the identified brick-and-mortar store 25₁-25_{L}. In other embodiments in which the UID is associated with at least a BMID and a BID, the BID may include one or more codes or other identifiers which identify the position or location of the wireless signal broadcasting device within the brick-and-mortar store identified by BMID. In any case, the wireless signal broadcasting device location identifiers, BID, are, in some embodiments, illustratively stored in the form of location coordinates relative to a base or reference set of coordinates. In some alternate embodiments, the wireless signal broadcasting device location identifiers, BID, may be stored in the form of one or more location codes identifying one or more of an aisle, shelf, merchandise section, merchandise area, product/service department, customer entry area, customer service area, point-of-sale system, produce scale and/or other identifier which identifies a particular location or position within all or an identified one of the plurality of brick-and-mortar stores 25₁-25_{L}. As one specific example in which a particular wireless signal broadcasting device 222 is located at the point-of-sale system 24₄ of one of the brick-and-mortar stores 25₁-25_{L}, the BID may be 4. As another specific example in which a particular wireless signal broadcasting device 222 is located at the point-of-sale system 24₅ at which a produce scale 220 is co-located, the BID may be PS5, e.g., to identify as the location of the wireless signal broadcasting device 222 the produce scale 220 (e.g., PS) of the point-of-sale system 24₅. As still another specific example in which the wireless signal broadcasting device 28₂ is located at or near the produce scale 26₁ in one of the brick-and-mortar stores 25₁-25_{L}, the BID may be PS1, e.g. to identify as the location of the wireless signal broadcasting device 28₂ the produce scale 26₁.

It will be understood that the wireless signal broadcasting device identity information stored in the wireless signal broadcasting device module 544 may include separately stored but associated values or codes for UID and any one or combination of BT, BMID and BID, or may be one or more codes or identifiers which include UID and any one or combination of BT, BMID and/or BID. As a specific example, the produce scale wireless signal broadcasting device 28₁ located above the produce scale 26₇ within the brick-and-mortar store 25₃ may have a UID of X34Q. In some embodiments, the wireless signal broadcasting device identity information may be stored in the form UID, BT, BMID, BID, and if in the above example BT=PS (produce scale), BMID=3 (brick-and-mortar store 25₃) and BID=7 (produce scale 26₇), which, in the above example, is X34Q, PS, 3, 7. In other embodiments, one or more of the BT, BMID and/or BID codes may be combined with others of the BT, BMID and/or BID codes. For example, BT, BMID and BID may be combined into a single code 137 (e.g., BT=1 for produce scales, BMID=3 for brick-and-mortar store 3 and BID=7 for produce scale 7 within the brick-and-mortar store 3), and in this example the wireless signal broadcasting device identity information may be stored in the form UID, BTBMIDBID, or X34Q, 137. In still other embodiments, all of the UID, BT, BMID and BID codes may be combined into a single code, and in this example the wireless signal broadcasting device identity information may be stored in the form of UIDBTBMIDBID, or X34Q137.

In some alternate embodiments, two or more of the BT, BMID and/or BID codes may be merged into a single code while in some cases retaining the remaining codes and in other cases omitting the remaining codes. As a second specific example, the point-of-sale wireless signal broadcasting device 222 located at the point-of-sale system 24₅ within the brick-and-mortar store 25₂ may have a UID of 3L6T. In some embodiments, BT=POS (e.g., point-of-sale wireless signal broadcasting device) and BID=5 (e.g., point-of-sale system 24₅) may be combined into a single identifier POS5 to identify the wireless signal broadcasting device 222 as a point-of-sale wireless signal broadcasting device located at point-of-sale system 24₅, and in embodiments in which the wireless signal broadcasting device identity information is stored in the wireless signal broadcasting device module 544 in the form UID, BTBID, BMID (and in which BMID=2 to identify the brick-and-mortar store 25₂), the foregoing example would be stored as 3L6T, POS5, 2. If BMID is combined with BT and BID to form a code BTBMIDBID, the foregoing example may be stored as 3L6T, POS25. In other embodiments, BMID may be omitted, and BT may be combined with BID in the form of a produce scale identifier to associate UID with a combined BTBID, e.g., such that the wireless signal broadcasting device identity information is stored in the form UID, BTBID. If, in the foregoing example, the BID is PSPOS5 to identify the produce scale 220 located at the point-of-sale system 24₅, the wireless signal broadcasting device identity information may thus be stored as 3L6T, PSPOS5 which associates in the wireless signal broadcasting device module 544 the UID of the wireless signal broadcasting device 222 located at the point-of-sale system 24₅ directly with the code that identifies the produce scale 220 located at the point-of-sale system 24₅. Similarly, BT and BID may be combined and BMID omitted with wireless signal broadcasting device identity information stored in the wireless signal broadcasting device module 544 for any of the wireless signal broadcasting devices 28₁-28_{P}. Using the codes/values from the example in the previous paragraph, if BID is PS7 to identify the produce scale 26₇ located at or near the wireless signal broadcasting device 28₁, the wireless signal broadcasting device identity information may be stored as X34Q, PS7 to thereby associate in the wireless signal broadcasting device module 544 the UID of the wireless signal broadcasting device 28₁ directly with the code that identifies the produce scale 26₇ located at or near the wireless signal broadcasting device 28₁. Those skilled in the art will recognize other techniques and combinations for identifying and storing the wireless signal broadcasting device identity information stored in the wireless signal broadcasting device module 544, and it will be understood that this disclosure contemplates any technique(s) or combination(s) of information from which the type of a wireless signal broadcasting device and/or location of a wireless signal broadcasting device relative to any reference location and/or relative to any particular produce scale 26₁-26_{N}, 220 in the retail enterprise 11 can be determined by the processor 50 based on a UID wirelessly transmitted by the customer's mobile communication device 16 at step 608 and received by the main server 12 at step 610. It will be further understood that in some embodiments each of BT, BMID and BID, individually or any combination thereof, is stored in the wireless signal broadcasting device module 544 and associated with, or combined with, UID, whereas in other embodiments only one or a subset of BT, BMID and BID need be stored in the wireless signal broadcasting device module 544 and associated with, or combined with, UID, in still other embodiments only the UID(s) of the one or more wireless signal broadcasting devices need be stored in the wireless signal broadcasting device module 544 and none of BT, BMID and BID need be stored in the wireless signal broadcasting device module 544 and/or associated with the one or more stored UID(s).

In any of the foregoing embodiments, the processor 50 is illustratively operable at step 612 to process a UID wirelessly received from the customer's mobile communication device 16 by searching for a corresponding UID stored in the wireless signal broadcasting device module 544 or other database that matches the wirelessly received UID. Thereafter at step 614, the processor 50 is illustratively operable to determine whether the matching UID corresponds to one of the wireless signal broadcasting devices associated with, i.e., located at or near, any of the produce scales 26₁-26_{N}, 220 in the retail enterprise, i.e., one of the wireless signal broadcasting devices 28₁-28_{P} or 222. In one embodiment, the processor 50 is operable to make such a determination at step 614 by processing the wireless signal broadcasting device type, BT, associated in the wireless signal broadcasting device module 544 with the wirelessly received UID to determine whether the wireless signal broadcasting device type is that of a point-of-sale system wireless signal broadcasting device type, e.g., POS wireless signal broadcasting device, or is that of a produce scale wireless signal broadcasting device type, e.g., PS wireless signal broadcasting device. In embodiments in which the UIDs of the wireless signal broadcasting devices 28₁-28_{P}, 222 are associated in the wireless signal broadcasting device module 544 or other database directly with produce scale codes that identify corresponding ones of the produce scales 26₁-26_{N}, 220, the processor 50 is further illustratively operable at step 614 to determine the identity, PSID, of the produce scale 26₁-26_{N}, 220 located at or near the identified wireless signal broadcasting device by identifying the produce scale code associated in the wireless signal broadcasting device module 544 with the matching UID. In other embodiments in which the UIDs of the wireless signal broadcasting devices 28₁-28_{P}, 222 are associated in the wireless signal broadcasting device module 544 or other database with brick-and-mortar store identification codes and/or location codes corresponding to specific locations or structures within brick-and-mortar stores other than produce scales 26₁-26_{N}, 220, the wireless signal broadcasting device module 544 further has stored therein associating such wireless signal broadcasting device locations with corresponding ones of the produce scales 26₁-26_{N}, 220. In such embodiments, the processor 50 is further operable at step 614 to process the BMID and/or BID values associated in the wireless signal broadcasting device module 544 with the wirelessly received UID to determine the location of the identified wireless signal broadcasting device relative to a reference location within the one of the brick-and-mortar stores 25₁-25_{L} in which the identified wireless signal broadcasting device is located, and to then identify a corresponding one, PSID, of the produce scales 26₁-26_{N}, 220 associated in the wireless signal broadcasting device module 544 with that wireless signal broadcasting device location, i.e., with the identified location (BID) of the identified wireless signal broadcasting device within the identified brick-and-mortar store 25₁-25_{L} (BMID).

In any case, if the processor 50 determines at step 614 that the wireless signal broadcasting device type, BT, associated in the wireless signal broadcasting device module 544 with the matching UID, is not a wireless signal broadcasting device type associated with, or which identifies, any of the wireless signal broadcasting devices 28₁-28_{P} associated with a corresponding one of the produce scales 26₁-26_{N}, or any of the wireless signal broadcasting devices 222 associated with any of the point-of-sale systems 24₁-24_{M} at which a produce scale 220 is located, the process 600 terminates as illustrated in FIG. 6A. If, however, the processor 50 determines at step 614 that the wireless signal broadcasting device type, BT, associated in the wireless signal broadcasting device module 544 with the matching UID, is a wireless signal broadcasting device type associated with, or which identifies, one of the wireless signal broadcasting devices 28₁-28_{P} associated with a corresponding one of the produce scales 26₁-26_{N}, or one of the wireless signal broadcasting devices 222 associated with any of the point-of-sale systems 24₁-24_{M} at which a produce scale 220 is located, the process 600 advances to step 616.

At step 616, the processor 50 is illustratively operable to control the communication circuitry 58 to wirelessly transmit to the mobile communication device 16 a customer identification request, i.e., a request or command for the customer's mobile communication device 16 to wirelessly transmit back to the main server 12 an identifier of the customer associated with the mobile communication device 16. Thereafter at step 618, the processor 300 of the customer's mobile communication device 16 is operable to receive the customer identification request, and at step 620 the processor 300 of the customer's mobile communication device 16 is operable to wirelessly transmit to the main server one or more wireless signals which contain(s) a customer identification, CID, which identifies at least one of the customer and the customer's mobile communication device 16.

In one embodiment, the memory 304 or data storage 306 of the customer's mobile communication device 16 may have stored therein the customer identifier, CID, in the form of an identifier which identifies the customer associated with, i.e., that carries, the mobile communication device 16. In such embodiments, CID illustratively is or includes the customer's enterprise membership identification code, EMSID, stored in the customer account data 404, or is another code or sets of codes to which the EMSID is linked or from which the EMSID can otherwise be determined by the processor 50 of the main server 12. In some alternate embodiments, the memory 304 or data storage 306 of the mobile communication device 16 may have stored therein the customer identifier, CID, in the form of communication information which identifies the mobile communication device 16 for purposes of wirelessly communicating therewith, e.g., a mobile telephone number and/or other communication identifier, which identifies the customer's mobile communication device 16 to the main server 12 for the purpose of communicating information from the main server 12 back to the customer's mobile communication device 16. In such embodiments, the customer account data 504 illustratively includes such communication information for each customer-member of the EMS program and such communication information for each customer-member is illustratively linked to or otherwise associated with one or more data components in the customer's customer account information stored in the customer account data 504 such that the processor 50 can search the customer account data 504 by communication information to locate the customer's communication information and identify the customer's purchase history stored in the customer purchase histories 508. In embodiments in which the communication information was transmitted by the customer's mobile communication device 16 to the main server 12 as part of step 608, steps 616-620 may illustratively omitted. In any case, the customer's mobile communication device 16 is operable, at step 620, to transmit to the main server 12 a customer identification, CID, whether in the form of an identifier of the customer-member of the EMS program, such as the customer's EMSID or other identifier, or in the form of an identifier of the customer's mobile communication device 16, such as the communication information of the customer's mobile communication device 16, and the customer identification, CID, is, in any embodiment, information which the processor 50 may use to search the customer account data 504 or other database to determine whether CID identifies, or is linked to data which identifies, a corresponding customer purchase history in the customer purchase histories database 508. Those skilled in the art will recognize other customer identifiers which may be stored in the customer's mobile communication device 16 and which may be wirelessly transmitted by the customer's mobile communication device 16 at step 620.

In some embodiments, the process steps 608-620 just described may be replaced by step 630, as shown in dashed outline, to which the process 600 advances following execution of step 606 (in which the processor 300 of the mobile communication device 16 has awoken and activated the PSC application 310 in response to detection of one or more unique identification signals broadcast by a wireless signal broadcasting device or other wireless signal broadcasting device. In some such embodiments, the memory 304 and/or data storage 306 of the customer's mobile communication device 16 illustratively has wireless signal broadcasting device information stored therein, as part of the PSC application 310, which relates to some or each of the various wireless signal broadcasting devices in one or more of the brick-and-mortar stores of the retail enterprise 11. In one embodiment in which the UID includes or has appended thereto a wireless signal broadcasting device type, BT, the wireless signal broadcasting device information stored in the customer's mobile communication device 16 illustratively is or includes wireless signal broadcasting device type information which identifies different wireless signal broadcasting device types, e.g., POS wireless signal broadcasting devices, PS wireless signal broadcasting devices, etc. as described above. In such embodiments, the processor 300 is operable at step 632 to process the unique identification signals broadcast by the wireless signal broadcasting device to determine the UID of the wireless signal broadcasting device and to then process the UID to determine the wireless signal broadcasting device type, BT, of the wireless signal broadcasting device. Thereafter at step 634, the processor 300 is illustratively operable to compare BT to the stored wireless signal broadcasting device information. Thereafter at step 636, the processor 300 is operable to determine whether the wireless signal broadcasting device is a POS wireless signal broadcasting device or a PS wireless signal broadcasting device. If so, the processor 300 is operable at step 638 to access the customer identification code, CID, stored therein or otherwise accessible thereto, and to then transmit the CID code and the UID of the wireless signal broadcasting device, which was determined at step 636 to be one of the wireless signal broadcasting devices 28₁-28_{P} or 222, to the main server 12. If the processor 300 determines at step 636 that the wireless signal broadcasting device detected at step 604 is a POS wireless signal broadcasting device or a PS wireless signal broadcasting device, the processor 300 is further illustratively operable at step 636 to process the produce scale, BMID and/or BID codes associated with the UID to identify a corresponding one, PSID, of the produce scales 26₁-26_{N}, 220 associated with that wireless signal broadcasting device, e.g., as described hereinabove with respect to step 612, such that the processor 300 is operable at step 638 to also wirelessly transmit to the main server 12 the produce scale identity, PSID. If the processor 300 otherwise determines at step 636 that the wireless signal broadcasting device detected at step 604 is not a POS wireless signal broadcasting device or a PS wireless signal broadcasting device, the process 600 terminates as illustrated in FIG. 6A.

In some embodiments that include step 320, the wireless signal broadcasting device information stored in the customer's mobile communication device 16 illustratively is or includes information that links, maps or otherwise associates wireless signal broadcasting device UIDs of at least the wireless signal broadcasting devices 28₁-28_{P}, 222 at some or all of the brick-and-mortar stores 25₁-25_{L} of the retail enterprise 11 to identifiers of the produce scales 26₁-26_{N}, 220 at which they are located, e.g., PSIDs. In other embodiments that include step 630, the wireless signal broadcasting device information acted upon by the processor 300 of the customer's mobile communication device 16 is not stored in the memory 304 and/or data storage 306, but is rather stored elsewhere and transmitted to or otherwise made accessible to the customer's mobile communication device 16 by the main server 12. In still other embodiments, the processor 50 of the main server 12 is operable to provide access by the processor 300 of the customer's mobile communication device 16 to such wireless signal broadcasting device information stored in the wireless signal broadcasting device module 544 or other database so that the processor 300 may thereafter process such wireless signal broadcasting device information as described above.

In any case, the process 600 advances from step 620, in embodiments that include steps 608-620, or from step 638 in embodiments that include step 620, to step 622. At step 622, the processor 50 of the main server 12 has the produce scale code, PSID, of the produce scale 26₁-26_{N}, 220 associated with, i.e., located at or near, the wireless signal broadcasting device detected by the customer's mobile communication device 16 at step 604. In embodiments of the process 600 that include steps 608-620, for example, the processor 50 identified PSID at steps 612 and 614, and in embodiments of the process 600 that instead include steps 632-638, the processor 300 of the customer's mobile communication device 16 determined PSID at steps 634 and 636. At step 622, the processor 50 further has the customer identification code, CID, wirelessly transmitted to the main server 12 by the customer's mobile communication device 16 at step 620 or at step 638. Following step 622, the processor 50 is illustratively operable at step 624 to determine whether the CID code transmitted to the main server 12 by the customer's mobile communication device 16 matches CID code stored in one or more databases, i.e., whether the CID code matches a corresponding CID code stored in the customer account data 504 or other database. The processor 50 is illustratively operable to execute step 624 of the process 600 by searching for the CID code in the customer account data 504 in embodiments in which the CID codes are stored in the customer accounts data 504, or in one or more other databases in which CID codes are stored in embodiments in which the CID codes are stored in such one or more other databases. The processor 50 is thereafter operable at step 626 to determine whether the search conducted at step 624 located a CID code in the customer account data 504 or other database. If so, the process 600 advances to step 628, and otherwise the process 600 terminates as illustrated in FIG. 6A.

At step 628, the processor 50 is illustratively operable to execute a produce scale control (PSC) process in which the processor 50 is operable to control the identified produce scale, i.e., that identified by the PSID code determined at steps 612 and 614 or at steps 634 and 636, to display one or more items contained in the customer purchase history of the identified customer, i.e., one or more items contained in the one of the customer purchase histories 508 that is associated with the customer identification code CID identified at steps 624 and 626 of the process 600. An embodiment of the PSC process executed by the processor 50 at step 628 is illustrated in FIG. 8.

Referring now to FIG. 6B, a simplified flow diagram is shown of an alternate process 650 for identifying a customer and a produce scale at a brick-and-mortar store 25₁-25_{L} of the retail enterprise 11. In one embodiment, the process 650 is illustratively stored in the PSC module 542 of the produce scale control (PSC) management module 540 (see FIG. 5) in the form of instructions executable by the processor 50 of the main server 12. The process steps of this portion of the process 650 will be described below for purposes of this disclosure as being executed by the processor 50 of the main server 12. In some alternate embodiments, e.g., that may or may not include a main server 12, this portion of the process 650 may alternatively be stored in the memory 34 (and/or data storage 36) of one or more of the local servers 22₁-22_{L} in the form of instructions executable by the processor 30 of the one or more local servers 22₁-22_{L}, stored in the memory of one of the point-of-sale systems 24₁-24_{M} within one or more of the brick-and-mortar enterprise stores 25₁-25_{L} in the form of instructions executable by a processor 200 associated with any such point-of-sale system 24₁-24_{M}, stored in the memory of one of the produce scales 26₁-26_{N}, 220 in the form of instructions executable by a processor 410 associated with any such produce scale 26₁-26_{N}, 220 and/or stored in a memory and executable by a processor of another system external to or supplemental to the system 10 illustrated FIG. 1. It will further be understood that portions of the process 650 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

The process 650 begins at step 652 where a customer supplies the customer's identification code, CID, to the main server 12 via one of the point-of-sale systems 24₁-24_{M} or via one of the produce scales 26₁-26_{N}. In embodiments of the system 10 that do not include a wireless signal broadcasting device 28₁-28_{P} located at or near one or more of the produce scales 26₁-26_{N}, and/or that do not include a wireless signal broadcasting device 222 located at or near one or more of the point-of-sale systems 24₁-24_{M} at which a produce scale 220 is co-located, a customer and produce scale may be otherwise identified to the main server 12 by manual supply of the customers identification code, CID, to a produce scale 26₁-26_{N} or to a point-of-sale system 24₁-24_{M} at which a produce scale 220 is co-located. In the former case, a customer may, for example, enter the customer's CID code into a keypad 402 or touch-screen display 400, present a CID code-carrying instrument to a sensor 408, or otherwise provide the customer's CID code to a produce scale 26₁-26_{N} at step 652, e.g., in the process of using the produce scale 26₁-26_{N} when selecting produce in a produce section or department of a brick-and-mortar store 25₁-25_{L}. In the latter case, a customer may, for example, enter the customer's CID into a keypad or touch-screen display 218, pass a CID code-carrying NFC device proximate to or in contact with an NFC interface 224, scan a CID code-carrying code using an item scanner 216 or otherwise provide the customer's CID code to a point-of-sale system 24₁-24_{M} at step 652 prior to or as part of a purchase transaction. In some embodiments, the customer's CID code is the customer's EMSID, although in other embodiments the customer's CID code may be or include other identification information that identifies the customer for purposes of accessing the customer's purchase history in the purchase histories database 508 as described above.

If, at step 652, the processor 50 of the main server 12 determines that a customer has supplied the customer's CID code to a point-of-sale system 24₁-24_{M} or to a produce scale 26₁-26_{N}, the processor 50 is thereafter illustratively operable at step 654 to determine whether the CID code supplied at step 652 matches CID code stored in one or more databases, i.e., whether the CID code matches a corresponding CID code stored in the customer account data 504 or other database. The processor 50 is illustratively operable to execute step 654 of the process 650 by searching for the CID code in the customer account data 504 in embodiments in which the CID codes are stored in the customer accounts data 504, or in one or more other databases in which CID codes are stored in embodiments in which the CID codes are stored in such one or more other databases. The processor 50 is thereafter operable at step 656 to determine whether the search conducted at step 654 located a matching CID code in the customer account data 504 or other database. If so, the process 650 advances to step 658, and otherwise the process 650 terminates as illustrated in FIG. 6B.

If the processor 50 determines at step 656 that a CID code matching that of the CID code supplied at step 652 was found in the customer account data 504 or other database, the processor 50 is further illustratively operable at step 654 to identify the produce scale associated with the device or system to which the customer supplied the customer's CID at step 652. If, for example, the customer supplied the customer's CID code to one of the produce scales 26₁-26_{N}, the processor 50 is operable to identify the produce scale code, PSID, associated with that produce scale 26₁-26_{N}, and if the customer supplied the customer's CID code to one of the point-of-sale systems 24₁-24_{M}, the processor 50 is operable to identify the produce scale code, PSID, associated with the produce scale 220 co-located at that point-of-sale system 24₁-24_{M}. Thus, following the “YES” branch of step 656, the processor 50 has the CID code of the customer that supplied the CID code at step 652 as well as the produce scale code, PSID, of the produce scale 26₁-26_{N} to which the customer supplied the customer's CID code or of the produce scale 220 co-located at the point-of-sale system 24₁-24_{M} to which the customer supplied the customer's CID code. Following the “YES” branch of step 656, the process 650 advances to step 658 where the processor 50 is operable to control the identified produce scale, i.e., that identified by the PSID code determined at step 656, to display one or more items contained in the customer purchase history of the identified customer, i.e., one or more items contained in the one of the customer purchase histories 508 that is associated with the customer identification code CID supplied by the customer at step 652 of the process 650. An embodiment of the PSC process executed by the processor 50 at step 658 is illustrated in FIG. 8.

### Produce Scale Menu Control Process

Referring now to FIG. 8, a simplified flow diagram is shown of an embodiment of a produce scale menu control process 800 executed by the processor 50 at step 628 of the process 600 illustrated in FIG. 6A and/or at step 658 of the process 650 illustrated in FIG. 6B. In one embodiment, the process 800 is or includes the PSC menu control module 544 stored in the memory 54 (and/or data storage 56) of the main server 12 in the form of instructions executable by the processor 50 of the main server 12. The process steps of this portion of the process 800 will be described below for purposes of this disclosure as being executed by the processor 50 of the main server 12. In some alternate embodiments, e.g., that may or may not include a main server 12, this portion of the process 800 may alternatively be stored in the memory 34 (and/or data storage 36) of one or more of the local servers 22₁-22_{L} in the form of instructions executable by the processor 30 of the one or more local servers 22₁-22_{L}, stored in the memory of one of the point-of-sale systems 24₁-24_{M} within one or more of the brick-and-mortar enterprise stores 25₁-25_{L} in the form of instructions executable by a processor 200 associated with any such point-of-sale system 24₁-24_{M}, stored in the memory of one of the produce scales 26₁-26_{N}, 220 in the form of instructions executable by a processor 410 associated with any such produce scale 26₁-26_{N}, 220 and/or stored in a memory and executable by a processor of another system external to or supplemental to the system 10 illustrated FIG. 1. It will further be understood that portions of the process 800 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

As will be described in detail below, the processor 50 is operable under the direction of the process 800 to modify a produce item graphic user interface (GUI) displayed on the display 400 of the identified produce scale 26, 220 to display one or more produce items contained in the purchase history that is stored in the purchase history database 508 associated with the customer identification code, CID, of the identified customer. Prior to execution of the process 800, the displays 400 of the produce scales 26₁-26_{N}, 220 may display, e.g., under conventional control of the processor 50, a produce scale graphic user interface (GUI) in the form of a conventional produce menu which illustratively includes a plurality of selectable graphic produce item elements and which further illustratively includes one or more sub-menus or ancillary menus of selectable GUI elements for facilitating identification of and/or searching for various produce items typically offered for sale by the retail enterprise 11. In one embodiment, such a produce scale GUI is stored in the produce scale menu module 526 (see FIG. 5) in the form of instructions executable by the processor 50 of the main server 12 to control the displays 400 of the produce scales 26₁-26_{N}, 220 to display the conventional produce scale GUI as described above.

Referring now to FIG. 9A, an example of one such produce scale GUI is shown which is displayed on a display 400 of one or more of the produce scales 26₁-26_{N}, 220, and which is illustratively displayed on the display 400 of the identified produce scale 26, 220, i.e., the produce scale 26, 220 identified by the produce scale identification code, PSID, identified as part of the produce scale identification process 600 or the process 650 described above. In the example illustrated in FIG. 9A, the produce scale GUI illustratively includes a produce menu GUI 900, a product menu control GUI 902 and a produce item search GUI 904. The produce menu GUI 900 illustratively includes a plurality of selectable graphic produce item elements 930 arranged in spaced-apart relationship in the produce menu GUI 900, e.g., in the form of a matrix of graphic produce items elements 930. As identified with respect to a first one 930₁ of such graphic produce item elements in the upper left portion of the menu 900, the element 930₁ illustratively includes an image section 932₁ which illustratively is or includes an image of the corresponding produce item and a text section 934₁ which illustratively includes a textual description of the produce item or other information relating to the produce item. In the illustrated example, each of the graphic produce elements 930 is thusly configured.

The produce menu control GUI 902 illustratively includes a number of different selectable graphic control elements which, when selected, cause the produce menu GUI 900 to display a subset of the total number of produce items offered for sale by the retail enterprise 11. In the illustrated embodiment, for example, the produce menu control GUI 902 illustratively includes four different alphabet range control elements 906₁-906₄, each of which corresponds to a different range of letters of the alphabet, and a “popular” control element 908. When any of the alphabet range control elements 906₁-906₄ is manually selected, the processor 50 illustratively controls the produce menu GUI 900 to display a plurality of produce items each beginning with a letter that is within the alphabet range of the selected control element 906₁-906₄. Thus, for example, if the control element 906₁ is selected, produce items beginning with the letters a-g will be displayed in the produce menu GUI 900, e.g., alphabetically. There may be several pages of such produce items elements 930, and the produce item search GUI 904 illustratively includes a page control GUI element 924 which may be manually selected or manipulated to page forward and or backward in any collection of produce items displayed in the produce menu GUI 900. Selection of the “popular” control element 908 illustratively results in the display in the produce menu GUI 900 of popular produce items, i.e., those produce items typically purchased by a wide range of customers of the retail enterprise 11. In the example illustrated in FIG. 9A, the popular control element 908 has been selected such that the produce menu GUI 900 displays a plurality of popular graphic produce item elements 930. Illustratively, one of the graphic control elements 906₁-906₄ or 908 may define a default setting of the produce menu GUI 900 such that the produce menu GUI corresponding to the default setting is displayed at the beginning of each customer use or transaction. In one such embodiment, the “popular” graphic control element 908 illustratively defines such a default setting.

The produce item search GUI 904 illustratively includes a manually selectable “key code” graphic element 920 and a manually selectable “search” graphic element 922. Selection of the “key code” graphic element 920 illustratively allows identification of produce items according to UPC code or other identification code. Selection of the “search” graphic element illustratively allows text searching for produce items. For example, in embodiments in which the display 400 is a touch-screen display, selection of the “key code” graphic element 920 illustratively produces a touch-screen key pad and/or other graphic elements in the produce menu GUI 900 which may be used to enter or selected a UPC code or other specific produce identification code, and selection of the “search” graphic element 922 illustratively produces a touch-screen key pad and/or other graphic search aids in the produce menu GUI 900 which may be used to search for and locate various produce items. In other embodiments, selection of the “key code” graphic element 920 and the “search” graphic element 922 may allow for manual entry of information via a hardware keypad 402.

Referring again to FIG. 8, and with a produce scale graphic user interface (GUI) of the type illustrated in FIG. 9A displayed on the display 400 of the identified produce scale, i.e., the one of the produce scales 26₁-26_{N}, 220 identified by the PSID code determined in the process 600 of FIG. 6A or the process 650 of FIG. 6B, the process 800 illustrated in FIG. 8 begins at step 802 where the processor 50 is operable to access the purchase history stored in the purchase history database 508 that is associated with the customer identification code, CID, determined in the process 600 illustrated in FIG. 6A or in the process 650 illustrated in FIG. 6B. Illustratively, the plurality of customer identification codes, CID, stored in the customer account data 504 or other database are each associated with, e.g., linked to, mapped to or otherwise identified with, a corresponding one of a plurality of customer histories stored in the customer history database 508, and accessing a particular customer purchase history in the database 508 may be accomplished by accessing the one of the plurality of customer purchase histories stored in the database 508 that is associated with the customer identification code CID of the corresponding customer. Following step 802, the processor 50 is illustratively operable at step 804 to sort the produce purchases contained in the accessed purchase history, i.e., to sort the ones of the items contained in the accessed customer purchase history that are produce items, according to one or more sorting criteria, and thereafter at step 806 the processor 50 is operable to modify the produce scale graphic user interface (GUI) displayed on the display 400 of the identified produce scale 26, 220 to include in the produce menu GUI selectable graphic produce item elements for any number, N, of the items in the sorted list of produce items contained in the accessed customer purchase history. N may illustratively be any positive integer.

In one embodiment, the processor 50 may execute steps 804 and 806 by sorting the produce purchases found in the accessed purchase history according to most frequently purchased produce items and then modifying the produce menu GUI displayed on the display 400 to include the “N” most frequently purchased produce items in the sorted list. Alternatively or additionally, the processor 50 may be operable at steps 804 and 806 to sort the produce purchases found in the accessed purchase history by purchase date, e.g., from most recently purchased to most distantly purchased, and to then modify the produce menu GUI displayed on the display 400 to include the “N” most recently purchased produce items in the sorted list. Alternatively or additionally still, the processor 50 may be operable at steps 804 and 806 to sort the produce purchases found in the accessed purchase history by season, e.g., from produce items in season or most in season to produce items out of season or most out of season, and to then modify the produce menu GUI displayed on the display 400 to include “N” in season ones, or the “N” most in season ones, of the produce items in the sorted list. Alternatively or additionally, the processor 50 may be operable at steps 804 and 806 to sort the produce purchases found in the accessed purchase history by the day of the week or month, and to then modify the produce menu GUI displayed on the display 400 to include “N” of the produce items contained in the sorted list that the customer typically purchases on the present day of the week or month. Those skilled in the art will recognize other criteria for sorting produce items contained in customer purchase histories and other techniques for modifying the produce menu GUIs displayed on the displays 400 of any of the produce scales 26₁-26_{N}, 220, and it will be understood that any such other sorting criteria or produce menu GUI modification techniques are contemplated by this disclosure.

Referring now to FIG. 9B, an example of the produce scale GUI 900 illustrated in FIG. 9A is shown as modified by the process 800 just described to produce a modified produce scale GUI 900′. In the example illustrated in FIG. 9B, the produce menu GUI 900′ is a modification of the produce menu GUI 900 illustrated in FIG. 9A, in accordance with steps 804 and 806 of the process 800 illustrated in FIG. 8, to include four graphic produce item elements 940₁-940₄ each of which is contained in the list of sorted produce items generated at step 804 of the process 800. Each graphic produce item element 940₁-940₄ illustratively includes a corresponding image section 942₁-942₄ which illustratively is or includes an image of the corresponding produce item and a corresponding text section 944₁-944₄ which illustratively includes a textual description of the produce item or other information relating to the produce item. In the illustrated example, the produce menu control GUI 902′ is also a modification of the produce menu control GUI 902 illustrated in FIG. 9A, as modified by the process 800 to include an additional manually selectable “Yours” control element 910. Illustratively, the “Yours” control element 910 corresponds to the modified produce scale GUI 900′ generated by the processor 50 based on produce items found in the purchase history associated with the identified customer CID. The “Yours” element 910, when selected, thus produces the modified product scale GUI 900′, and is included to allow customers to search for and locate produce items using the conventional graphic elements such as the control elements 906₁-906₄ and 908 and/or the key code and search elements 920 and 922, and to then be able to return to and display the graphic produce items elements 940₁-940₄ generated by the process 800 and displayed in the “Yours” produce menu GUI 900′ depicted in FIG. 9B. Those skilled in the art will recognize other graphic techniques for modifying the produce menu GUI to display one or more of the produce items in the sorted list generated at step 804 of the process 800, or for generating one or more new produce menu GUIs to display such one or more produce items, and it will be understood that any such other graphic techniques and/or displays are contemplated by this disclosure.

In some alternative embodiments, the processor 50 may be operable at step 806 to add one or more additional produce item GUI elements to the produce scale GUI 900′. In some such embodiments, for example, the processor 50 may be operable as part of step 802 to also access the product/service pricing data 506 in the server database 502 to generate a list of produce items currently in inventory in the brick-and-mortar store 25 in which the identified one of the produce scales 26₁-26_{N}, 220 is located. Thereafter at step 804, the processor 50 may be operable in such alternate embodiments to modify the sorted list of produce items found in the purchase history associated with CID by appending to, or including in, the sorted list one or more such items included in the generated list of produce items currently in inventory but not included in the original, i.e., unmodified, list of produce items found in the purchase history associated with CID. And thereafter at step 806, the processor 50 may be further operable to include in the modified produce scale GUI 900′ a selectable produce item GUI element for each of the one or more current inventory produce items appended to or included in the modified sorted list of produce items.

In one such alternate embodiment, for example, the processor 50 may be operable at step 804 to first compare the sorted or unsorted list, or subset thereof, of produce items found in the purchase history associated with CID to the list of produce items currently in inventory to determine whether one or more produce items in the list or subset thereof of produce items found in the purchase history associated with CID is/are not currently in inventory, i.e., in stock, in the brick-and-mortar store 25 in which the identified one of the produce scales 26₁-26_{N}, 220 is located. If one or more such produce items is/are not currently in inventory, the processor 50 may be further operable at step 804 to process the list of produce items currently in inventory to determine whether the list contains one or more suitable replacement or substitute items which the identified customer may have selected as a replacement or substitute for such one or more produce items contained in the identified customer's purchase history that is/are not currently in inventory. If the processor 50 determines that the list of produce items currently in inventory contains one or more such suitable replacement produce items, the processor 50 is further operable at step 804 to include such one or more suitable replacement produce items in the modified sorted list of produce items. In this alternate embodiment, the processor 50 is thus operable to further modify the produce scale GUI 900′ to include selectable produce item GUI elements for produce items not found in the purchase history associated with CID but determined by the processor 50 to be currently in stock and anticipated to potentially be selected by the identified customer in place of items found in the purchase history associated with CID but not currently in inventory in the brick-and-mortar store 25 in which the identified one of the produce scales 26₁-26_{N}, 220 is located.

In other alternate embodiments, the processor 50 may be operable at step 804 to compare the list of produce items currently in inventory in the brick-and-mortar store 25 in which the identified one of the produce scales 26₁-26_{N}, 220 is located with the list of produce items found in the purchase history associated with the CID, to determine, based on the comparison, the likelihood or probability that the customer will purchase one or more such produce items currently in inventory that is/are not in the sorted list of produce items found in the purchase history associated with the CID, or that is/are in the sorted list of produce items found in the purchase history but with irregular, inconsistent or infrequent purchase pattern(s), and to then modify the sorted list of produce items found in the purchase history associated with CID by appending to, or including in, the sorted list one or more of the produce items in the list of produce items currently in inventory determined by the processor 50 to have a sufficiently high likelihood or probability of being purchased by the identified customer. In such alternate embodiments, the processor 50 is thus operable to further modify the produce scale GUI 900′ to include selectable produce item GUI elements for produce items not found in the purchase history associated with CID, or found in the purchase history but having irregular, inconsistent or infrequent purchase pattern(s), and in any case determined by the processor 50 to be currently in stock and have a high likelihood or probability of being selected for purchase by the identified customer. In some such embodiments, one or more such additional produce items may illustratively be seasonal items, infrequently stocked items, or the like.

In still other alternate embodiments, the processor 50 may be operable at step 804 to compare the list of produce items currently in inventory in the brick-and-mortar store 25 in which the identified one of the produce scales 26₁-26_{N}, 220 is located with the list of produce items found in the purchase history associated with the CID, to determine, based on the comparison, one or more such produce items currently in inventory that is/are not in the sorted list of produce items found in the purchase history associated with the CID but determined by the processor 50 to be similar, synergistic with and/or complementary to, e.g., in family, type, kind, quality, texture, etc., to one or more produce items found in the purchase history, and to then modify the sorted list of produce items found in the purchase history associated with CID by appending to, or including in, the sorted list one or more of the produce items in the list of produce items currently in inventory determined by the processor 50 to be similar to, synergistic with and/or complementary to one or more of the produce items in the sorted list of produce items. In such alternate embodiments, the processor 50 is thus operable to further modify the produce scale GUI 900′ to include selectable produce item GUI elements for produce items not found in the purchase history associated with CID but determined by the processor 50 to be currently in inventory and similar to, synergistic with and/or complementary to one or more of the produce items in the sorted list of produce items. In some such embodiments, one or more such additional produce items may illustratively be suggested items, promotional items, infrequently stocked items, or the like.

Referring again to FIG. 8, the process 800 advances from step 806 to step 808 where the processor 50 is illustratively operable to execute a PSID operation process. Example embodiments of the PSID menu process are illustrated in FIGS. 10A and 10B, and such processes will be described in detail below. Following execution of step 808, the process 800 terminates and returns to step 628 of the process 600 or to step 658 of the process 650.

### PSID Operation Process

### Embodiment 1

Referring now to FIG. 10A, a simplified flow diagram is shown of an embodiment of the PSID operation process 1000 executed by the processor 50 at step 808 of the process 800 illustrated in FIG. 8. The process 1000 is illustratively executed by the processor 50 in embodiments in which the process 800 is executed as step 628 of the process 600 illustrated in FIG. 6A. As will be described in detail below, the processor 50 is illustratively operable under the direction of the process 1000 to maintain the modified produce menu GUI, e.g., the modified produce menu GUI 900′ illustrated in FIG. 9B, displayed on the display 400 of the identified produce scale 26₁-26_{N}, 220 for as long as the PID 28₁-28_{P}, 222 detected by the identified customer's mobile communication device 16 at step 604 of the process 600 remains an in-range PID relative to the identified customer's mobile communication device 16.

The framework of the process 1000 illustrated in FIG. 10A is illustratively identical to that of the process 600 illustrated in FIG. 6A. In FIG. 10A, for example, a portion of the process 1000, i.e., the portion to the left of the left-most vertical line and centered under the heading “MCD,” illustratively represents one or more processes executed by the processor 300 of the identified customer's mobile communication device 16, and in one embodiment this portion of the process 1000 is or includes the PSC App 310 stored in the memory 304 (and/or data storage 306) of the mobile communication device 16 in the form of instructions executable by the processor 300 of the mobile communication device 16. The process steps of this portion of the process 1000 will therefore be described below for purposes of this disclosure as being executed by the processor 300 of the customer's mobile communication device 16, although in other embodiments one or more of the process steps may be executed by one or more other processors of one or more other devices, systems or servers. Another portion of the process 1000, i.e., the portion between the left-most vertical line and the right-most vertical line in FIG. 10A and centered under the heading “PID,” represents action taken by the PID identified by the customer's mobile communication device 16 at step 604 of the process 600. Yet another portion of the process 1000, i.e., the portion to the right of the right-most vertical in FIG. 10A, and centered under the heading “Main Server,” illustratively represents one or more processes executed by the processor 50 of the main server 12, and in one embodiment this portion of the process 1000 is or includes the PSC operation module 546 stored in the memory 54 (and/or data storage 56) of the main server 12 in the form of instructions executable by the processor 50 of the main server 12. The process steps of this portion of the process 1000 will therefore be described below for purposes of this disclosure as being executed by the processor 500 of the main server 12, although in other embodiments one or more of the process steps may be executed by one or more other processors of one or more other devices, systems or servers as described above.

In the process 1000 illustrated in FIG. 10A, as in the process 600 illustrated in FIG. 6A, the PID is illustratively implemented in the form of a wireless signal broadcasting device, e.g., a conventional wireless signal broadcasting device. In this respect, item 1001 illustratively represents continued or periodic broadcasting of wireless identification signals by the in-range wireless signal broadcasting device 28₁-28_{P}, 222 detected at step 604 of the process 600, and the process steps of the process 1000 will therefore be described within this same context and framework. As described in detail above, however, one or more of the PID(s) may alternatively be embodied in one or more different forms, and those skilled in the art will recognize that any modification(s) to one or more steps of the process 1000 to accommodate such one or more different PID embodiments would be a mechanical step for a skilled artisan. In any case, at step 1002, the processor 300 of the customer's mobile communication device 16 is illustratively operable to determine whether a wireless identification signal has been detected by the communication circuitry 312 of the mobile communication device 16 within a predefined time period since last detecting a wireless identification signal. If not, this indicates that none of the PIDs 28₁-28_{P}, 222 is currently in-range relative to the customer's mobile communication device 16, and in such cases the process 1000 terminates as illustrated in FIG. 10A. In some embodiments, the predefined time period is illustratively between 500 milliseconds and 1 second. In some alternative embodiments, the predefined time period may be between 1 millisecond and several seconds, although it will be understood that shorter or longer time periods are contemplated by this disclosure.

If, at step 1002 the processor 300 determines that a wireless identification signal has been detected within the predefined time period since last detecting a wireless identification signal, the process 1000 advances to step 1004 where the processor 300 is operable to receive the most recently detected wireless identification signal broadcast by the in-range wireless signal broadcasting device 28₁-28_{P}, 222 and detected by the mobile communication device 16. Thereafter at step 1006, the processor 300 is operable in one embodiment to determine whether the unique identification code, UID, contained in the most recently detected wireless identification signal matches that of the previously detected wireless identification signal, i.e., the most recent previously detected wireless identification signal. If so, the process 1000 advances to step 1008 where the processor 300 is illustratively operable to control the communication circuitry 312 to wirelessly transmit one or more wireless signals to the main server 12 which carry a hold request or other message or information indicative of having determined that the UID contained in the most recently detected wireless identification signal matches that of the previously detected wireless identification signal. If, at step 1006, the processor 300 otherwise determines that the UID contained in the most recently detected wireless identification signal does not match that of the previously detected wireless identification signal, this indicates that the identified customer′ mobile communication device 16 has moved sufficiently away from the wireless signal broadcasting device 28₁-28_{P}, 222 detected at step 604 such that the wireless signal broadcasting device 28₁-28_{P}, 222 detected at step 604 is no longer an in-range wireless signal broadcasting device relative to the customer's mobile communication device, but that another wireless signal broadcasting device 28₁-28_{P}, 222 is now an in-range wireless signal broadcasting device relative to the identified customer′ mobile communication device 16. In such cases, the process 1000 advances to step 1010 where the processor 300 is illustratively operable to control the communication circuitry 312 to wirelessly transmit one or more wireless signals to the main server 12 which carry a stop request or other message or information indicative of having determined that the UID contained in the most recently detected wireless identification signal does not match that of the previously detected wireless identification signal.

At step 1012, the main server 12 receives the one or more wireless signals transmitted by the identified customer's mobile communication device 16 at step 1008 or 1010, and at step 1014 the processor 50 is illustratively operable to process the received wireless signal(s) to determine whether the received wireless signal(s) contain(s) a hold request or a stop request. If the received wireless signal(s) contain(s) a hold request, the process 1000 advances to step 1016 where the processor 50 is illustratively operable to control the identified one of the produce scales 26₁-26_{N}, 220 to maintain the modification of the produce scale GUI executed at step 806 of the process 800, i.e., to maintain the modified produce scale GUI 900′, and the process 1000 loops from step 1016 back to step 1002. If, at step 1014, the processor 50 determines that the received wireless signal(s) contain(s) a stop request, the process 1000 advances to step 1018 where the processor 50 is illustratively operable to control the identified one of the produce scales 26₁-26_{N}, 220 to reset the produce scale GUI to its default produce scale GUI, e.g., to the produce scale GUI 900 illustrated in FIG. 9A. The process 1000 thereafter terminates and returns to the process 800 illustrated in FIG. 8.

In some embodiments of the process 1000, step 1006 may alternatively be executed by the processor 50 of the main server 12. In some such embodiments, for example, the processor 300 of the mobile communication device 16 may include only a single wireless signal transmission step following step 1004 at which the processor 300 is operable to control the communication circuitry 312 of the mobile communication device 16 to wirelessly transmit the most recently detected wireless identification signal to the main server 12. Upon receipt by the main server 12 from the mobile communication device 16 of the most recently detected wireless signal identification signal at step 1012, the processor 50 is then operable to execute the function of step 1006 in place of that of step 1014 to determine whether the unique identification code, UID, contained in the most recently detected wireless identification signal matches that of the previously detected wireless identification signal, i.e., the most recent previously detected wireless identification signal. If so, the process 1000 advances to step 1016 and otherwise the process 1000 advances to step 1018.

In some embodiments, the process 1000 illustratively includes a step 1020 which is illustratively executed by the processor 50 of the main server 12 in tandem with the execution of steps 1012-1018. In embodiments which include step 1020, the processor 50 is operable at step 1020 to execute a produce scale data processing process in which the processor 50 is operable to monitor operation of the identified one of the produce scales 26₁-26_{N}, 220 to determine produce pricing information, i.e., to determine the price(s) of one or more produce items placed by the identified customer on the identified one of the produce scales 26₁-26_{N}, 220, and to include such produce pricing information in a purchase transaction presently being conducted by the identified customer or in a purchase transaction to be subsequently conducted by the identified customer. Example embodiments of the produce scale data processing process executed at step 1020, in embodiments which include step 1020, are illustrated in FIGS. 11 and 12, and such processes will be described in detail below.

### PSID Operation Process

### Embodiment 2

Referring now to FIG. 10B, a simplified flow diagram is shown of another embodiment 1050 of the PSID operation process executed by the processor 50 at step 808 of the process 800 illustrated in FIG. 8. The process 1050 is illustratively executed by the processor 50 in embodiments in which the process 800 is executed as step 658 of the process 650 illustrated in FIG. 6B. As will be described in detail below, the processor 50 is illustratively operable under the direction of the process 1050 to maintain the modified produce menu GUI, e.g., the modified produce menu GUI 900′ illustrated in FIG. 9B, displayed on the display 400 of the identified produce scale 26₁-26_{N}, 220 for as long as the customer transaction remains in progress, i.e., as long as the identified customer is engaging the identified produce scale 26₁-26_{N} or as long as a purchase transaction remains in progress between the identified customer and the one of the point-of-sale systems 24₁-24_{M} at which the identified produce scale 220 is located. In one embodiment, the process 1050 is illustratively stored in the PSC operation module 546 of the produce scale control (PSC) management module 540 in the form of instructions executable by the processor 50 of the main server 12. The process steps of this portion of the process 1050 will therefore be described below for purposes of this disclosure as being executed by the processor 50 of the main server 12. In some alternate embodiments, e.g., that may or may not include a main server 12, this portion of the process 1050 may alternatively be stored in the memory 34 (and/or data storage 36) of one or more of the local servers 22₁-22_{L} in the form of instructions executable by the processor 30 of the one or more local servers 22₁-22_{L}, stored in the memory of one of the point-of-sale systems 24₁-24_{M} within one or more of the brick-and-mortar enterprise stores 25₁-25_{L} in the form of instructions executable by a processor 200 associated with any such point-of-sale system 24₁-24_{M}, stored in the memory of one of the produce scales 26₁-26_{N}, 220 in the form of instructions executable by a processor 410 associated with any such produce scale 26₁-26_{N}, 220 and/or stored in a memory and executable by a processor of another system external to or supplemental to the system 10 illustrated FIG. 1. It will further be understood that portions of the process 1050 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

The process 1050 begins at step 1052 where the processor 50 is illustratively operable to determine whether the customer transaction involving the identified produce scale 26₁-26_{N}, 220 is still in progress. If the customer transaction corresponds to use by the identified customer of an identified one of the produce scales 26₁-26_{N}, the processor 50 is illustratively operable to execute step 1052 by monitoring the operation of the identified produce scale 26₁-26_{N}. For example, as long as the identified produce scale 26₁-26_{N} is actively weighing produce, i.e., the produce scale weight is greater than a predefined minimum weight, and for a predetermined time period thereafter, the processor 50 determines at step 1052 that the identified customer is continuing to actively engage the identified produce scale 26₁-26_{N}. As another example, the processor 50 may be operable at step 1052 to determine that the identified customer is actively engaging the identified produce scale 26₁-26_{N} following supply of the customer's identification code, CID, to the identified produce scale 26₁-26_{N} until a predefined time period has elapsed with the identified produce scale 26₁-26_{N} inactive, i.e., the produce scale weight is less than or equal to a predefined minimum weight. As yet another example, the processor 50 may be operable at step 1052 to determine that the identified customer is actively engaging the identified produce scale 26₁-26_{N} following supply of the customer's identification code, CID, to the identified produce scale 26₁-26_{N} until the identified produce scale 26₁-26_{N} receives a manually selected reset command, e.g., via the keypad 402, touch-screen display 400 and/or sensor 404 output. As still another example, the processor 50 may be operable at step 1052 to determine that the identified customer is actively engaging the identified produce scale 26₁-26_{N} following supply of the customer's identification code, CID, to the identified produce scale 26₁-26_{N} until a new customer identification code, CID, is supplied to the identified produce scale 26₁-26_{N}, i.e., until a customer identification code, CID, identifying another customer is entered into or otherwise supplied to the identified produce scale 26₁-26_{N}.

If, at step 1052, the customer transaction corresponds to a purchase transaction between the identified customer and the one of the plurality of point-of-sale systems 24₁-24_{M} at which the identified produce scale 220 is located, the processor 50 is illustratively operable to execute step 1052 by monitoring the operation of the identified point-of-sale system 24₁-24ₘ. For example, until the identified point-of-sale system 24₁-24_{M} produces a signal indicating that the current purchase transaction is complete following supply of the identified customer's identification code, CID, to the identified point-of-sale system 24₁-24_{M}, the processor 50 illustratively determines at step 1052 that the customer purchase transaction is still in progress. As another example, until the identified point-of-sale system 24₁-24_{M} receives a new customer identification code, CID, following supply of the identified customer's identification code, CID, to the identified point-of-sale system 24₁-24_{M}, the processor 50 illustratively determines at step 1052 that the customer purchase transaction is still in progress. Those skilled in the art will recognize other techniques for determining at step 1052 whether the customer transaction is still in progress, and it will be understood that any such other techniques are contemplated by this disclosure.

If, at step 1052, the processor determines that the customer transaction is still in progress, the process 1050 advances to step 1054 where the processor 50 is illustratively operable to control the identified one of the produce scales 26₁-26_{N}, 220 to maintain the modified produce scale GUI executed at step 806 of the process 800, e.g., to maintain the modified produce scale GUI 900′ illustrated in FIG. 9B, and the process 1050 thereafter loops from step 1054 back to step 1052. If, at step 1052, the processor 50 determines that the customer transaction is not still in progress, i.e., is no longer in progress, the process 1050 advances to step 1056 where the processor 50 is illustratively operable to control the identified one of the produce scales 26₁-26_{N}, 220 to reset the produce scale GUI of the identified one of the produce scales 26₁-26_{N}, 220 to its default produce scale GUI, e.g., the produce scale GUI 900 illustrated in FIG. 9A. The process 1050 thereafter terminates and returns to the process 800 illustrated in FIG. 8.

In some embodiments, the process 1050 illustratively includes a step 1020 which is illustratively executed by the processor 50 of the main server 12 in tandem with the execution of steps 1052-1056. In embodiments which include step 1020, the processor 50 is operable at step 1020 to execute a produce scale data processing process in which the processor 50 is operable to monitor operation of the identified one of the produce scales 26₁-26_{N}, 220 to determine produce pricing information, i.e., to determine the price(s) of one or more produce items placed by the identified customer on the identified one of the produce scales 26₁-26_{N}, 220, and to include such produce pricing information in a purchase transaction presently being conducted by the identified customer or in a purchase transaction to be subsequently conducted by the identified customer. Example embodiments of the produce scale data processing process executed at step 1020, in embodiments which include step 1020, are illustrated in FIGS. 11 and 12, and such processes will be described in detail below.

### Produce Scale Data Processing Process

Referring now to FIG. 11, a simplified flow diagram is shown of an embodiment 1100 of the produce scale data processing process executed by the processor 50 at step 1020 of the processes 1000 and 1050 illustrated in FIGS. 10A and 10B respectively, in embodiments of the processes 1000 and 1050 which include step 1020. In one embodiment, the process 1100 is illustratively stored in the PSC data processing module 548 of the produce scale control (PSC) management module 540 in the form of instructions executable by the processor 50 of the main server 12. The process steps of this portion of the process 1100 will therefore be described below for purposes of this disclosure as being executed by the processor 50 of the main server 12. In some alternate embodiments, e.g., that may or may not include a main server 12, this portion of the process 1100 may alternatively be stored in the memory 34 (and/or data storage 36) of one or more of the local servers 22₁-22_{L} in the form of instructions executable by the processor 30 of the one or more local servers 22₁-22_{L}, stored in the memory of one of the point-of-sale systems 24₁-24_{M} within one or more of the brick-and-mortar enterprise stores 25₁-25_{L} in the form of instructions executable by a processor 200 associated with any such point-of-sale system 24₁-24_{M}, stored in the memory of one of the produce scales 26₁-26_{N}, 220 in the form of instructions executable by a processor 410 associated with any such produce scale 26₁-26_{N}, 220 and/or stored in a memory and executable by a processor of another system external to or supplemental to the system 10 illustrated FIG. 1. It will further be understood that portions of the process 1100 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

The process 1100 begins at step 1102 where the processor 50 of the main server 12 is operable to monitor the display 400 of the identified one of the produce scales 26₁-26_{N}, 220 for selection of one of the one or more selectable produce item GUI elements 940. Thereafter at step 1104, the processor 50 is operable to determine whether any of the one or more selectable produce item GUI elements 940 has been selected. If so, this means that the customer intends to use the identified one of the produce scales 26₁-26_{N}, 220 to weigh a produce item corresponding to that identified by the selected produce item GUI element 940, and the process 50 advances to step 1106. Otherwise the process 1100 loops back to the beginning of step 1104.

At step 1106, the processor 50 is operable to monitor weight applied to the item tray or platform of the identified one of the produce scales 26₁-26_{N}, 220, and thereafter at step 1108 the processor 50 is operable to determine whether the weight is greater than a threshold weight, W_{TH}. Illustratively, the threshold weight, W_{TH}, is a so-called tare weight, such that when the weight applied to the identified one of the produce scales 26₁-26_{N}, 220 exceeds W_{TH}, this indicates that the produce item corresponding to the selected produce item GUI 940 has been placed on the item or platform of the identified one of the produce scales 26₁-26_{N}, 220. If the processor 50 determines at step 1108 that the weight applied to the identified one of the produce scales 26₁-26_{N}, 220 is greater than W_{TH}, the process 1100 advances to step 1110, and otherwise the process 1100 loops back to the beginning of step 1108.

At step 1110, the processor 50 is operable to continue to monitor the weight applied to the item tray or platform of the identified one of the produce scales 26₁-26_{N}, 220 and to determine whether such weight has stabilized, e.g., whether the change in the detected weight per unit time is less than a threshold change amount. If so, this indicates that the identified one of the produce scales 26₁-26_{N}, 220 has captured the weight of the produce item placed thereon, and the process 1100 advances to step 1112. Otherwise the process 1100 loops back to the beginning of step 1110.

At step 1112, the processor 50 is operable to access the product/service pricing data 506 to determine the unit price of the produce item corresponding to the produce item GUI element 940 selected at step 1104, and to then calculate the price of the produce item presently being weighed as a function of the weight of the produce item determined at step 1110 and the unit price of the produce item determined from to product/service pricing data 506. Thereafter at step 1114, the processor 50 is operable to determine whether the identified one of the produce scales 26₁-26_{N}, 220 is one of the produce scales 26₁-26_{N} located within the brick-and-mortar store 25, e.g., within or near a produce department of the brick-and-mortar store 25, or is a produce scale 220 not included in the produce scales 26₁-26_{N}, 220 but instead coupled to or otherwise associated with one of the point-of-sale systems 24₁-24_{M} within the brick-and-mortar store 25. In the former case, the identified one of the produce scales 26₁-26_{N}, 220 is an “in-store produce scale,” and in the latter case the identified one of the produce scales 26₁-26_{N}, 220 is a “POS produce scale.” In embodiments in which the identified one of the produce scales 26₁-26_{N}, 220 is identified according to the process 600 illustrated in FIG. 6A, such a determination is made at steps 612 and 614, and in embodiments in which the identified one of the produce scales 26₁-26_{N}, 220 is identified according to the process 650 illustrated in FIG. 6B, such a determination is made at step 652. In either case, the processor 50 is, at step 1114, already in possession of the type of the identified one of the produce scales 26₁-26_{N}, 220. If, at step 114, the identified one of the produce scales 26₁-26_{N}, 220 is a POS produce scale the process 1100 advances to step 1116, and otherwise the identified one of the produce scales 26₁-26_{N}, 220 is an in-store produce scale and the process 1100 advances to step 1118.

At step 1116, the identified one of the produce scales 26₁-26_{N}, 220 is a POS produce scale and the processor 50 is operable at step 1116 to add the produce item identified at steps 1102 and 1104 and its price calculated at step 1112 to the purchase transaction presently being conducted at the one of the point-of-sale systems 24₁-24_{M} at which the identified one of the produce scales 26₁-26_{N}, 220 is co-located or with which the identified one of the produce scales 26₁-26_{N}, 220 is otherwise associated. After the produce item is removed from the identified one of the produce scales 26₁-26_{N}, 220, e.g., determined by monitoring the weight applied to the produce tray or platform of the identified one of the produce scales 26₁-26_{N}, 220, the processor 50 is operable to control the identified one of the produce scales 26₁-26_{N}, 220 to reset its weight, e.g., to its tare weight. Following step 1116, the process 1100 loops back to the beginning of step 1102.

At step 1118, the identified one of the produce scales 26₁-26_{N}, 220 is an in-store produce scale and the processor 50 is operable at step 1118 to identify and temporarily assign a storage block or area of the pre-processed produce items repository 510 to the identified customer, e.g., by associating the assigned storage area or block in the pre-processed produce items repository 510 with an identifier of the customer, e.g. CID and/or EMSID. Illustratively, the assigned storage area or block in the pre-processed produce items repository 510 is maintained by the processor 50 until the produce items contained therein are processed by one of the point-of-sales systems 24₁-24_{M}, or after a predetermined amount of time has passed since assigning the storage area or block in the pre-processed produce items repository 520. In any case, the processor 50 is further operable at step 1118 add the produce item identified at steps 1102 and 1104 and its price calculated at step 1112 to the storage area or block of the pre-processed produce items repository 510 assigned to the identified customer, e.g., by storing such information in the storage area or block of the pre-processed produce items repository 510 associated with CID.

In some embodiments, the process 1100 further includes steps 1120 and 1122, and in such embodiments the process 1100 advances from step 1118 to step 1120 where the processor 50 is operable to modify the produce scale GUI, e.g., the produce scale GUI 900′, to include a selectable GUI element for indicating completion of the identified customer's use of the identified one of the produce scales 26₁-26_{N}, 220, e.g., a “completion” GUI element. Thereafter at step 1122, the processor 50 is operable to determine whether the completion GUI element has been selected. If not, the process 1100 loops back to step 1102. In embodiments which include steps 1120 and 1122, the processor 50 is further illustratively operable at step 1122 to control the identified one of the produce scales 26₁-26_{N}, 220 to reset its weight, e.g., to its tare weight, after the produce item is removed therefrom. In embodiments which do not include steps 1120 and 1122, the processor 50 is illustratively operable to do so at step 1118.

If, at step 1122, the processor 50 determines that the completion GUI element has been selected, the processor 50 is illustratively operable to control the identified one of the produce scales 26₁-26_{N}, 220 to reset its weight, e.g., to its tare weight, and to also reset the produce scale GUI to its default state, e.g., to the produce scale GUI 900 illustrated in FIG. 9A. In embodiments which do not include steps 1120 and 1122, the processor 50 is illustratively operable to control the identified one of the produce scales 26₁-26_{N}, 220 to reset its weight at step 1118. In any such embodiments which do not include steps 1120 and 1122, the process 1100 illustratively loops back to step 1102 from step 1118, and the processor 50 is operable in some such embodiments to control the identified one of the produce scales 26₁-26_{N}, 220 to reset its weight and/or to reset the produce scale GUI to its default state after passage of some predetermined period of time of inactivity of the identified one of the produce scales 26₁-26_{N}, 220.

Referring now to FIG. 12, a simplified flow diagram is shown of an embodiment 1200 of a purchase transaction process executed by the processor 50 in embodiments in which a customer conducts a purchase transaction at one of the point-of-sales systems 24₁-24_{M} and in which produce item and pricing information for one or more produce items is presently contained in a storage area or block in the pre-processed produce items repository 510 temporarily assigned to the customer. In one embodiment, the process 1200 is illustratively stored in the PSC data processing module 548 of the produce scale control (PSC) management module 540 in the form of instructions executable by the processor 50 of the main server 12. The process steps of this portion of the process 1200 will therefore be described below for purposes of this disclosure as being executed by the processor 50 of the main server 12. In some alternate embodiments, e.g., that may or may not include a main server 12, this portion of the process 1200 may alternatively be stored in the memory 34 (and/or data storage 36) of one or more of the local servers 22₁-22_{L} in the form of instructions executable by the processor 30 of the one or more local servers 22₁-22_{L}, stored in the memory of one of the point-of-sale systems 24₁-24_{M} within one or more of the brick-and-mortar enterprise stores 25₁-25_{L} in the form of instructions executable by a processor 200 associated with any such point-of-sale system 24₁-24_{M}, stored in the memory of one of the produce scales 26₁-26_{N}, 220 in the form of instructions executable by a processor 410 associated with any such produce scale 26₁-26_{N}, 220 and/or stored in a memory and executable by a processor of another system external to or supplemental to the system 10 illustrated FIG. 1. It will further be understood that portions of the process 1200 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

The process 1200 begins at step 1202 where the processor 50 is operable to determine the identity of the customer at the one of the point-of-sale systems 24₁-24_{M} at which the customer is presently conducting, or has arrived to conduct, a purchase transaction. In some embodiments in which at least one of the PIDs 28₁-28_{P} is located at the one of the point-of-sale systems 24₁-24_{M}, or is located sufficiently close to the one of the point-of-sale systems 24₁-24_{M} to allow for detection thereof by the customer's mobile communication device 16, the processor 50 may be operable to determine the identity of the customer at step 1202 by determining CID and/or EMSID via the process 600 illustrated in FIG. 6A. In some alternative embodiments, the customer may manually or otherwise provide the customer's identity information, e.g., CID and/or EMSID, to the one of the point-of-sale systems 24₁-24_{M}, e.g., in accordance with the process 650 illustrated in FIG. 6B, and the processor 50 may be operable in such embodiments to determine the customer's identity at step 1202 by monitoring the one of the point-of-sale systems 24₁-24_{M}. In any case, the processor 50, after completion of step 1202, has either or both of the CID and EMSID of the customer conducting, or about to conduct, the purchase transaction at the one of the point-of-sale systems 24₁-24_{M}.

Following step 1202, the process 1200 advances to step 1204 where the processor 50 is operable to access the pre-processed produce items repository 510 and to search the repository 510 using the identified customer's CID and/or EMSID for a matching CID and/or EMSID. Thereafter at step 1206, the processor 50 is operable to determine whether a CID and/or EMSID stored in the pre-processed produce item repository 510 matches the CID and/or EMSID of the customer determined at step 1202. If the processor 50 finds a match, this means that a corresponding area or block of the pre-processed produce items repository 510 has been temporarily assigned to the identified customer and contains therein product and price information for one or more produce items previously processed by the identified customer according to the process 1100 and now presented by the identified customer at the one of the point-of-sale systems 24₁-24_{M} as part of the current purchase transaction. The processor 50 is then operable at step 1208 to add the information and corresponding prices stored in the area or block of the pre-processed produce items repository 510 temporarily assigned to the identified customer for each produce item contained therein to the purchase transaction being conducted at the one of the point-of-sale systems 24₁-24_{M}. Thereafter at step 1210, the processor 50 is operable to clear area or block of the pre-processed produce items repository 510 temporarily assigned to the identified customer, e.g., to delete therefrom information and corresponding prices of the one or more produce items and/or all customer information.

If, at step 1206, the processor 50 does not find a match, this means that no area or block of the pre-processed produce items repository 510 has been temporarily assigned to the identified customer, and in such cases the process 1200 advances to step 1212. The process 1200 likewise advances to step 1212 following step 1210. At step 1212, the processor 50 is illustratively operable, along with the one of the point-of-sales systems 28₁-28_{M} at which the customer is presently conducting a purchase transaction, to complete the purchase transaction presently being conducted by the identified customer. Thereafter upon completion, the process 1200 terminates.

Embodiments of the processes 600, 800, 1000 and 1200 have been illustrated and described herein in which the customer's mobile communication device 16 and the main server 12 communicate wirelessly, e.g., via the public network 14 and, in some embodiments, also via the Wifi access point 30, in relation to providing information to the main server 12 relating to the position or location of the customer's mobile communication device 16 within or in relation to one of the brick-and-mortar stores 25 of the retail enterprise 11, e.g., relative to one or more of the position identification devices 28₁-28_{P}, and/or relating the identity of the customer/customer's mobile communication device 16, e.g., the customer's identification code, CID. In some alternative embodiments, the customer's mobile communication device 16 may alternatively conduct any such wireless communications with a point-of-sale system 24₁-24_{M} processing the customer's purchase transaction, i.e., between the processors 200 and 300 via the respective communication circuits 210 and 312. In such embodiments, the point-of-sale system 24₁-24_{M} processing the customer's current purchase transaction may be operable to communicate information received from the customer's mobile communication device 16 to the main server 12 via, e.g., the private network 20, and the main server 12 may likewise be operable to communicate information to the customer's mobile communication device 16 by providing such information to the point-of-sale system 24₁-24_{M} processing the customer's current purchase transaction, e.g., via the private network 20, with the point-of-sale system 24₁-24_{M} processing the customer's current purchase transaction then transmitting such information to the customer's mobile communication device 16. In such embodiments in which the point-of-sale system 24₁-24_{M} processing the customer's current purchase transaction is coupled to one of the local hub servers 22₁-22_{L}, that local hub server 22 is illustratively operable to pass any such communications between the main server 12 and the point-of-sale system 24₁-24_{M} processing the customer's current purchase transaction. In such embodiments that do not include any such local hub server 22, such communications may take place directly between the main server 12 and the point-of-sale system 24₁-24_{M} processing the customer's current purchase transaction.

In other alternative embodiments in which the point-of-sale system 24₁-24_{M} processing the customer's current purchase transaction is coupled to one of the local hub servers 22₁-22_{L}, the customer's mobile communication device 16 may alternatively conduct any such wireless communications with the local hub server 22 coupled to the point-of-sale system 24₁-24_{M} processing the customer's current purchase transaction, i.e., between the processors 30 and 300 via the respective communication circuits 38 and 312. In such embodiments, the local hub server 22 may be operable to communicate information received from the customer's mobile communication device 16 to the main server 12 via, e.g., the private network 20, and the main server 12 may likewise be operable to communicate information to the customer's mobile communication device 16 by providing such information to the local hub server 22, e.g., via the private network 20, with the local hub server 22 then transmitting such information to the customer's mobile communication device 16.

In still further alternative embodiments in which one or more portions of the process 600, 800, 1000 and 1200 executed by the processor 50 is executed by at least one processor of one or any combination of the point-of-sale system 24₁-24_{M} processing the customer's current purchase transaction or a local hub server 22 coupled thereto coupled to the main server 12, the customer's mobile communication device 16 may alternatively conduct any such wireless communications with any one or combination of the point-of-sale system 24₁-24_{M} processing the customer's current purchase transaction, a local hub server 22 coupled thereto and/or the main server 12.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected. For example, it will be understood that while several process steps in various sequences have been illustrated and described herein with respect to the processes 600, 650, 800, 1000, 1050, 1100 and 1200 any one or more such processes 600, 650, 800, 1000, 1050, 1100 and 1200 may alternatively include more, fewer and/or different steps, and that any such steps may be executed in different sequences from those illustrated and described, without departing from the scope of the concepts and techniques described herein.

In the embodiments described herein, the position identification devices 28₁-28_{P}, 220 have been described as being implemented as wireless signal broadcasting devices, e.g., conventional radio frequency broadcasting beacons, configured to broadcast wireless signals each containing UID. In some alternate embodiments, one or more of the PIDs may be implemented as wireless signal transceivers configured to can broadcast and receive wireless signals and/or as wireless signal receivers configured to receive broadcast wireless signals, e.g., broadcast by a mobile communication device or other device and, in some cases, to communicate directly (wired and/or wirelessly) with the main server 12, one or more of the local hub servers 22 and/or one or more of the POS systems 24. In some such embodiments, one or more of the wireless signal transceivers and/or receivers may include one or more conventional processors and one or more memory devices having instructions stored therein executable by the one or more processors to execute one or more of steps for determining an identity of an individual carrying a mobile communication device within and/or near a store 25.

In other alternate embodiments, one or more PIDs 28₁-28_{P}, 220 may be implemented in the form of a combination of conventional Global Positioning System (GPS) satellites and a GPS receiver on-board a mobile communication device.

In other alternate embodiments, one or more PIDs 28₁-28_{P}, 220 may be implemented in the form of one or more in-store WiFi Access Points which establish one or more in-store or store-wide hotspot having a unique internet access ID (HotSpotID) accessible by a mobile communication device. In such embodiments, the server 12 may determine a location of a mobile communication device in accordance with the unique internet access ID used by the mobile communication device to communicate with the mobile communication device.

In other alternate embodiments, one or more PIDs 28₁-28_{P}, 220 may be implemented in the form of a combination of the earth's Geomagnetic Field and a magnetometer on-board a mobile communication device. In such embodiments, the server 12 may determine the location of a mobile communication device in accordance with the unique magnetic field signature captured by the magnetometer and wirelessly transmitted to the server 12 by the mobile communication device. In such embodiments, the server database may have one or more maps, tables, lists or the like mapping magnetic signature profiles within one or more of the stores to locations or positions within one or more of the stores, and the server 12 may be operable in such embodiments to determine the in-store location or position of a mobile communication device by comparing the unique magnetic field signature wirelessly transmitted by the mobile communication device to the stored magnetic signature profiles.

In other alternate embodiments, one or more of the PIDs 28₁-28_{P}, 220 may be implemented in the form of a combination of a camera on-board a mobile communication device and a product label affixed to product or product location within a store. In such embodiments, the camera may be operated to capture an image of the product label and wirelessly transmit the image to the server. The server may then compare the image to stored product data to determine the in-store location thereof.

In other alternate embodiments, one or more of the PIDs 28₁-28_{P}, 220 may be implemented in the form of a combination of a mobile communication device with a keypad and a customer/employee application operating on the mobile communication device. In such embodiments, the customer/employee application may display one or more manually selectable GUI elements for manually entering the location of the mobile communication device, and the mobile communication device may then wirelessly transmit the location information to the server.

In other alternate embodiments, one or more of the PIDs 28₁-28_{P}, 220 may be implemented in the form of a wireless signal transmission device, e.g., RFID Tag, NFC device, etc., attached to customer-selected product. In such embodiments, the wireless signal transmission device may be configured to wirelessly transmit product information (e.g., brand, size, etc.) and/or location (e.g., department, aisle, shelf position, etc.) to a mobile communication device which then wirelessly transmits the information to the server.

In other alternate embodiments, one or more of the PIDs 28₁-28_{P}, 220 may be implemented in the form of a combination of one or more in-store Cameras and a server-based facial and/or product recognition application. In some such embodiments, the server may process camera images and/or video and compare facial images with stored customer images to identify customers. In other embodiments, the server may process the camera images and/or video and compare product images, e.g., in customer's possession (basket, hand-carried, etc.) with stored product images, and then predict the customer's identity based on information contained in customer shopping histories.

In other alternate embodiments, one or more PIDs 28₁-28_{P}, 220 may be implemented in the form of a combination of one or more electromagnetic radiation (EMR) generators positioned within a store 25 and a mobile communication device with a camera and/or microphone. In such embodiments, the EMR may be generated in one or more spectral ranges, and be made to vary locally from store-to-store and throughout each store in one or more detectable EMR properties or characteristics, and/or EMR having different properties or characteristics may be generated in each store and in different areas of each store, such that in any case different stores, and different areas within each store, will be subject to different generated EMR properties or characteristics. The different EMR properties and/or characteristics generated in each store and in each area of each store may be stored in an EMR database, and local EMR properties/characteristics may be detected by a mobile communication device and wirelessly transmitted to the server which may then compare such received information to the EMR database to determine the location of the mobile communication device. Examples of such EMR generators and corresponding EMR detectors include, but are not limited to, one or more visible Light Generators and a camera on-board a mobile communication device, one or more audible frequency Generators and a microphone on-board a mobile communication device, one or more radio frequency generators and a radio frequency generator on board a mobile communication device, and the like.

In other alternate embodiments, one or more PIDs 28₁-28_{P}, 220 may be implemented in the form of one or more mobile communication devices of one or more in-store customers or in-store Employees. In such embodiments, in-store mobile communication devices may be configured to periodically broadcast signals detected by a customer's mobile communication device and/or transmitted directly to the server. Such broadcast signals be or include “location information” signals based on one or more “hard events” such as a recently received unique identification signal transmitted by an in-store wireless signal broadcasting device, a recently scanned or imaged product code, detected product device data, recently received GPS data, recently used HotSpotID data, recently detected EMR data, and/or the like. Alternatively or additionally, the one or more broadcast signals may be or include location information signals based on one or more “soft events” such as locally detected sounds (generated or not), locally detected light (generated or not), locally detected RF signals, and/or the like.

In any of the foregoing embodiments, information may be transmitted, receive and/or processed by any one or combination of any system or device disclosed herein.

What is claimed is:

1. A method of customizing a produce scale menu at a retail enterprise, the method comprising:
associating, with a processor in a first database, each of a plurality of produce scales with a different one of a plurality of device codes, each of the plurality of produce scales located in a brick-and-mortar store of the retail enterprise,
associating, with the processor in the first or a second database, each of a plurality of customer codes with a different one of a plurality of purchase histories and also with a different one of a plurality of customers of the retail enterprise, each of the plurality of purchase histories containing information relating to items previously purchased by a corresponding one of the plurality of customers,
in response to receipt of a device code, identifying with the processor the one of the plurality of device codes in the first database that matches the received device code,
in response to receipt of a customer code, identifying with the processor the one of the plurality of customer codes in the first or the second database that matches the received customer code, and
if the one of the plurality of purchase histories associated in the first or the second database with the identified one of the plurality of customer codes contains one or more produce items, modifying a produce menu displayed on a display device of the one of the plurality of produce scales associated in the first database with the identified one of the device codes to display at least one of the one or more produce items.

2. The method of claim 1, further comprising receiving, with the processor, the received customer code.

3. The method of claim 2, wherein receiving the received customer code comprises receiving, with the processor, the received customer code from a keypad associated with the one of the plurality of produce scales associated in the first database with the identified one of the device codes.

4. The method of claim 3, wherein the processor is coupled via a communication network to the one of the plurality of produce scales,
and wherein the method further comprises receiving, with the processor, the received device code from the one of the plurality of produce scales via the communication network, the received device code one of received from the one of the plurality of produce scales in response to a request by the processor for the received device code via the communication network and accessed by the processor directly from the one of the plurality of produce scales via the communication network.

5. The method of claim 2, wherein receiving the received customer code comprises receiving, with the processor, the received customer code from a keypad associated with one of a plurality of point-of-sale systems of the retail enterprise to which the one of the plurality of produce scales associated in the first database with the identified one of the device codes is coupled.

6. The method of claim 5, wherein the processor is coupled via a communication network to the one of the plurality of point-of-sale systems,
and wherein the method further comprises receiving, with the processor, the received device code from the one of the plurality of point-of-sale systems via the communication network, the received device code one of received from the one of the plurality of point-of-sale systems in response to a request by the processor for the received device code via the communication network, and accessed by the processor directly from the one of the plurality of point-of-sale systems via the communication network.

7. The method of claim 2, wherein receiving the received customer code comprises receiving, with the processor, the received customer code from a near-field communication interface associated with the one of the plurality of produce scales associated in the first database with the identified one of the device codes.

8. The method of claim 7, wherein each of the plurality of customer codes is further associated in the first or the second database with a different one of a plurality of access codes,
and wherein receiving the received customer code from the near-field communication interface comprises:
receiving, with the processor, an access code from the near-field communication device,
identifying with the processor the one of the plurality of access codes in the first or the second database that matches the received access code, and
identifying with the processor the one of the plurality of customer codes associated in the first or the second database with the identified one of the plurality of access codes.

9. The method of claim 7, wherein the processor is coupled via a communication network to the one of the plurality of produce scales,
and wherein the method further comprises receiving, with the processor, the received device code from the one of the plurality of produce scales via the communication network, the received device code one of received from the one of the plurality of produce scales in response to a request by the processor for the received device code via the communication network, and accessed by the processor directly from the one of the plurality of produce scales via the communication network.

10. The method of claim 2, wherein receiving the received customer code comprises receiving the received customer code from a near-field communication interface associated with one of a plurality of point-of-sale systems of the retail enterprise to which the one of the plurality of produce scales associated in the first database with the identified one of the device codes is coupled.

11. The method of claim 10, wherein each of the plurality of customer codes is further associated in the first or the second database with a different one of a plurality of access codes,
and wherein receiving the received customer code from the near-field communication interface comprises:
receiving, with the processor, an access code from the near-field communication device,
identifying with the processor the one of the plurality of access codes in the first or the second database that matches the received access code, and
identifying with the processor the one of the plurality of customer codes associated in the first or the second database with the identified one of the plurality of access codes.

12. The method of claim 10, wherein the processor is coupled via a communication network to the one of the plurality of point-of-sale systems,
and wherein the method further comprises receiving, with the processor, the received device code from the one of the plurality of point-of-sale systems via the communication network, the received device code one of received from the one of the plurality of produce scales in response to a request by the processor for the received device code via the communication network, and accessed by the processor directly from the one of the plurality of produce scales via the communication network.

13. The method of claim 2, wherein receiving the received customer code comprises receiving the received customer code from an electronic funds transfer reading device associated with one of a plurality of point-of-sale systems of the retail enterprise to which the one of the plurality of produce scales associated in the first database with the identified one of the device codes is coupled.

14. The method of claim 13, wherein each of the plurality of customer codes is further associated in the first or the second database with a different one of a plurality of payment codes, each of the plurality of payment codes associated in the first or the second or a third database with a different one of a plurality of instruments of electronic funds transfer,
and wherein receiving the customer code from the electronic funds transfer reading device comprises:
receiving, with the processor, a payment code from the electronic funds transfer reading device,
identifying with the processor the one of the plurality of payment codes in the first or the second or the third database that matches the received payment code, and
identifying with the processor the one of the plurality of customer codes associated in the first or the second or the third database with the identified one of the plurality of payment codes.

15. The method of claim 13, wherein the processor is coupled via a communication network to the one of the plurality of point-of-sale systems,
and wherein the method further comprises receiving, with the processor, the received device code from the one of the plurality of point-of-sale systems via the communication network, the received device code one of received from the one of the plurality of produce scales in response to a request by the processor for the received device code via the communication network, and accessed by the processor directly from the one of the plurality of produce scales via the communication network.

16. The method of claim 2 wherein receiving the received customer code comprises wirelessly receiving, under control of the processor, the received customer code wirelessly transmitted by a mobile communication device carried by the one of the plurality of customers.

17. The method of claim 16, wherein each of the plurality of customer codes is further associated in the first or the second database with a different one of a plurality of access codes,
and wherein wirelessly receiving the received customer code comprises:
receiving, with the processor, an access code wirelessly transmitted by the mobile communication device carried by the one of the plurality of customers,
identifying with the processor the one of the plurality of access codes in the first or the second database that matches the received access code, and
identifying with the processor the one of the plurality of customer codes associated in the first or the second database with the identified one of the plurality of access codes.

18. The method of claim 1, further comprising wirelessly receiving, under control of the processor, the received device code and the received customer code wirelessly transmitted by a mobile communication device carried by the one of the plurality of customers associated in the first or the second database with the identified one of the plurality of customer codes.

19. The method of claim 18 wherein the device code wirelessly transmitted by the mobile communication device and received under control of the processor is broadcast by a wireless signal broadcasting device positioned at or near the one of the plurality of produce scales.

20. The method of claim 18 wherein the processor is coupled via a communication network to a plurality of point-of-sale systems and the one of the plurality of produce scales is coupled to one of the plurality of point-of-sale systems,
and wherein the device code wirelessly transmitted by the mobile communication device and received under control of the processor is broadcast by a wireless signal broadcasting device positioned at or near the one of a plurality of point-of-sale devices to which the one of the plurality of produce scales is coupled.
